(19) United States
(12) Patent Application Publication
(10) Pub. No.: US 2026/0065140 A1
(43) Pub. Date: Mar. 5, 2026

(54) ADVERSARIAL TRAINING OF ARTIFICIAL INTELLIGENCE AGENTS

(71) Applicant: Maplebear Inc., San Francisco, CA (US)

(72) Inventors: Levi Boxell, Brownsburg, IN (US); Tilman Drerup, Palo Alto, CA (US)

(21) Appl. No.: 18/824,677

(22) Filed: Sep. 4, 2024

(51) Int. Cl. G06N 20/00

(52) U.S. Cl. CPC G06N 20/00

(57) ABSTRACT

A system artificial intelligence (AI) agent is trained to act on behalf of an online system. The system AI agent comprises a large language model that has been pre-trained using a set of system constraints and a set of system objectives. The system AI agent is trained adversarially using training service requests from a plurality of different user AI agents of different types to determine resolutions to the training service requests. Once trained, the system AI agent may determine resolutions to service requests of users of the online system. In some embodiments, the system agent may determine the resolutions via messaging with user AI agents that represent the users. The online system may further train the system AI agent (and in some embodiments the user AI agents) based in part on the resolutions to the service requests.

### BACKGROUND

Conventional online systems receive requests from users for a variety of reasons. These include requests to order items, requests for information about a topic, and requests to provide a service, among many others. Conventionally, a user sends a request to an online system and is then presented with a response. In the case of a user request to order one or more items, e.g., following a search query, the online system may respond with a user interface that arranges a set of products that the user may select. The user then decides whether to buy one of the products or continue searching for an alternate product. Because the user has to search individually for a product and then decide whether to purchase it, this process can become rather time intensive for a large list of products. Moreover, the user is typically left with a binary choice when presented with a product (i.e., to purchase it or not) and is not able to negotiate with the conventional online retailer to facilitate a sale of the product.

Being able to use a machine-learned model to act on behalf of an online retailer may help address these issues. However, effectively training such a machine-learned model can be difficult due to, e.g., the breadth of different negotiation strategies it would likely have to employ in order to effectively address interactions with users.

### SUMMARY

In accordance with one or more aspects of the disclosure, an online system manages adversarial training of artificial intelligence (AI) agents. The AI agents include user AI agents and one or more system AI agents. The system AI agent is a large language model, and the large language model may have been pre-trained using a set of system constraints and a set of system objectives. The user AI agents are each large language models. The user AI agents may have been pretrained using training sets of user constraints and training sets of user objectives. Each of the user AI agents may be associated with a respective type that may describe, e.g., a different negotiation style of the user AI agent. The type of a user AI agent may be based in part on the set of training user constraints and/or the set of training user objectives that are used in the pre-training of the user AI agent. In some embodiments, a user AI agent may have a user training constraint and/or training user objective that differs from at least one other user AI agent.

The online system creates an instance of a system AI agent. The online system may retrieve training service requests from a user AI agent of the set of AI agents (e.g., that are associated with different types). The online system may manage rounds of messaging between the user AI agent and the system AI agent to achieve resolutions to the training service requests.

The online system may generate training examples based on the training service requests from the user AI agent. In some embodiments, some or all of the training examples include, for a given service request and corresponding resolution, at least one round of messaging of the rounds of messaging. The online system may label some or all of the training examples. The labeling may be, e.g., based on a comparison of a resolution of the training example to a metric associated with the online system. The online system may train the system AI agent using some or all of the labeled training examples. The trained system AI agent may be deployed in a real-world context to address service requests received from real-world users of the online system.

Note that one or more system AI agents may be trained across a variety of types of user agents. As such, the online system may train in an adversarial manner, the one or more system AI agents to handle a variety of different users, negotiation tactics, negotiations with users (via user devices), negotiations with user AI agents acting on behalf of users, etc.

### BRIEF DESCRIPTION OF THE DRAWINGS

FIG. 1 illustrates an example system environment for an online system, in accordance with one or more embodiments.

FIG. 2 illustrates an example system architecture for an online system, in accordance with some embodiments.

FIGS. 3A-3B is an example sequence diagram describing adversarial training of a system AI agent using a user AI agent, in accordance with some embodiments.

FIGS. 4A-4C is an example sequence diagram describing management of messaging between a system AI agent and a user AI agent that is associated with a user of a user device 405, in accordance with some embodiments.

FIGS. 5A-5B is an example sequence diagram describing management of messaging between a system AI agent and a user device of a user, in accordance with some embodiments.

FIG. 6 is a flowchart for a method of adversarial training of AI agents, in accordance with some embodiments.

### DETAILED DESCRIPTION

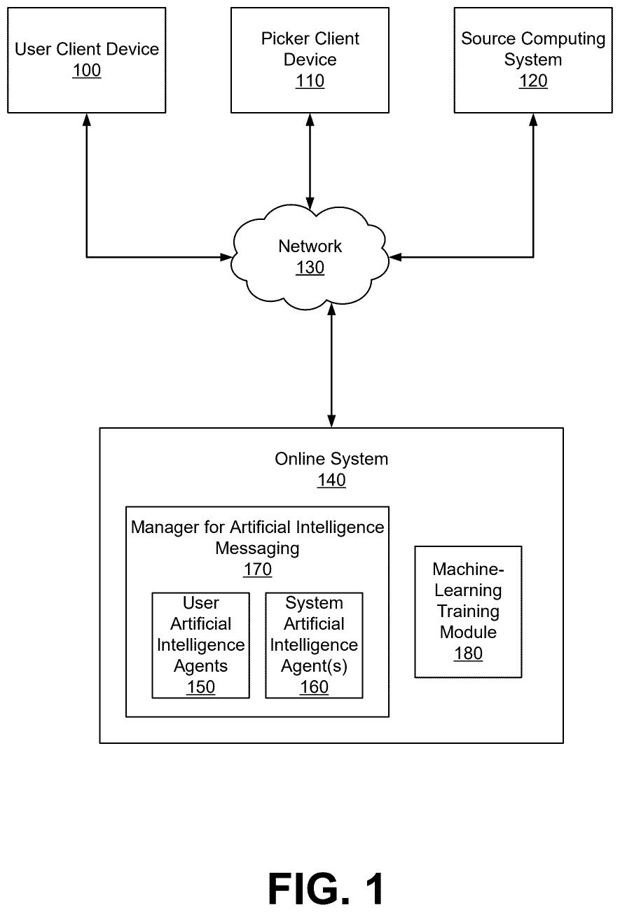

FIG. 1 illustrates an example system environment for an online system 140, in accordance with one or more embodiments. The system environment illustrated in FIG. 1 includes a user client device 100, a picker client device 110, a source computing system 120, a network 130, and an online system 140. Alternative embodiments may include more, fewer, or different components from those illustrated in FIG. 1, and the functionality of each component may be divided between the components differently from the description below. Additionally, each component may perform their respective functionalities in response to a request from a human, or automatically without human intervention.

Although one user client device 100, picker client device 110, and source computing system 120 are illustrated in FIG. 1, any number of users, pickers, and sources may interact with the online system 140. As such, there may be more than one user client device 100, picker client device 110, or source computing system 120. Additionally, a user client device 100 operated by a user, the source computing system 120, a device (e.g., similar to the user client device 100) through which an advertiser interacts with the online system 140, or some combination thereof, may be rereferred to as a “user device.”

The user client device 100 is a client device through which a user may interact with the picker client device 110, the source computing system 120, or the online system 140. The user client device 100 can be a personal or mobile computing device, such as a smartphone, a tablet, a laptop computer, or desktop computer. In some embodiments, the user client device 100 executes a client application that uses an application programming interface (API) to communicate with the online system 140.

A user uses the user client device 100 to place an order with the online system 140. An order specifies a set of items to be delivered to the user. An “item,” as used herein, means a good or product that can be provided to the user through the online system 140. The order may include item identifiers (e.g., a stock keeping unit (SKU) or a price look-up (PLU) code) for items to be delivered to the user and may include quantities of the items to be delivered. Additionally, an order may further include a delivery location to which the ordered items are to be delivered and a timeframe during which the items should be delivered. In some embodiments, the order also specifies one or more sources from which the ordered items should be collected.

The user client device 100 presents an ordering interface to the user. The ordering interface is a user interface that the user can use to place an order with the online system 140. The ordering interface may be part of a client application operating on the user client device 100. The ordering interface allows the user to search for items that are available through the online system 140 and the user can select which items to add to an “ordering list.” A “ordering list,” as used herein, is a tentative set of items that the user has selected for an order but that has not yet been finalized for an order. The ordering list may alternatively be referred to as a “cart” or “shopping cart.” The ordering interface allows a user to update the ordering list, e.g., by changing the quantity of items, adding or removing items, or adding instructions for items that specify how the item should be collected.

The user client device 100 may generate a service request. The service request may be for items specified in an ordering list that the user intends to order. The user client device 100 provides the service request to the online system 140. As described below the online system 140 may use artificial intelligence (AI) agents to coordinate the order. The ordering interface may include an AI agent option for selection (e.g., by the user). In some embodiments, responsive to the selection, the user client device 100 may send a service request to the online system 140 to coordinate the order using AI agents.

The user client device 100 may determine one or more of a set of user constraints and/or one or more of a set of user objectives. User constraints and user objectives control in part how a user AI agent negotiates on behalf of the user with a system AI agent representing the online system 140. User constraints (e.g., maximum budget) are restrictions that the user AI agent representing interests of the user abides by while negotiating a resolution for a service request. And user objectives (e.g., minimizing number of substitute items) are goals that the user AI agent attempts to achieve while negotiating the order with the system AI agent. Note in some embodiments, a user objective can also be a user constraint. For example, for a first order a user may not care about delivery time, and just set delivery time as a user objective. But in a later order, the user may need the items by a set time, and set the delivery time as a user constraint.

Values for user constraints and/or user objectives may be received from the user. In some embodiments, the user client device 100 may infer a value for a user constraint and/or a user objective based in part on, e.g., information about the user (e.g., user data). Note that each of the user constraints may be associated with a respective weight value, and each of the objectives may be associated with a respective weight value. In some embodiments, different user constraints may have different weight values and/or different user objects have different weight values. For example, a maximum budget may have a higher weighting than, e.g., allowing substitutions for items. In some embodiments, a service request may also include one or more user constraints and/or one or more user objectives. In other embodiments, the user client device 100 provides one or more user constraints and/or one or more user objectives to the online system 140 separate from the service request.

In some embodiments, the user client device 100 receives a proposed agreement relating to the service request from the online system 140. The user client device 100 may present, e.g., via the ordering interface, the proposed agreement for approval or disapproval by the user. If the user rejects the proposed agreement, the user may provide a reason for the rejection. The user client device 100 may provide the reason for the rejection to the online system 140 which may have the AI agents negotiate a new proposed agreement based in part on the reason. Once a proposed agreement is approved by the user, the user client device 100 may coordinate with the online system 140 to complete the approved order.

The user client device 100 may receive additional content from the online system 140 to present to a user. For example, the user client device 100 may receive coupons, recipes, or item suggestions. The user client device 100 may present the received additional content to the user as the user uses the user client device 100 to place an order (e.g., as part of the ordering interface).

Additionally, the user client device 100 includes a communication interface that allows the user to communicate with a picker that is servicing the user's order. This communication interface allows the user to input a text-based message to transmit to the picker client device 110 via the network 130. The picker client device 110 receives the message from the user client device 100 and presents the message to the picker. The picker client device 110 also includes a communication interface that allows the picker to communicate with the user. The picker client device 110 transmits a message provided by the picker to the user client device 100 via the network 130. In some embodiments, messages sent between the user client device 100 and the picker client device 110 are transmitted through the online system 140. In addition to text messages, the communication interfaces of the user client device 100 and the picker client device 110 may allow the user and the picker to communicate through audio or video communications, such as a phone call, a voice-over-IP call, or a video call.

The picker client device 110 is a client device through which a picker may interact with the user client device 100, the source computing system 120, or the online system 140. The picker client device 110 can be a personal or mobile computing device, such as a smartphone, a tablet, a laptop computer, or a desktop computer. In some embodiments, the picker client device 110 executes a client application that uses an application programming interface (API) to communicate with the online system 140.

The picker client device 110 receives orders from the online system 140 for the picker to service. A picker services an order by collecting the items listed in the order from a source. The picker client device 110 presents the items that are included in the user's order to the picker in a collection interface. The collection interface is a user interface that provides information to the picker on which items to collect for a user's order and the quantities of the items. In some embodiments, the collection interface provides multiple orders from multiple users for the picker to service at the same time from the same source location. The collection interface further presents instructions that the user may have included related to the collection of items in the order. Additionally, the collection interface may present a location of each item at the source, and may even specify a sequence in which the picker should collect the items for improved efficiency in collecting items. In some embodiments, the picker client device 110 transmits to the online system 140 or the user client device 100 which items the picker has collected in real time as the picker collects the items.

The picker can use the picker client device 110 to keep track of the items that the picker has collected to ensure that the picker collects all the items for an order. The picker client device 110 may include a barcode scanner that can decode an item identifier encoded in a machine-readable label (e.g., a barcode or a QR code) coupled to an item. The picker client device 110 compares this item identifier to items in the order that the picker is servicing, and if the item identifier corresponds to an item in the order, the picker client device 110 identifies the item as collected. In some embodiments, rather than or in addition to using a barcode scanner, the picker client device 110 captures one or more images of the item and identifies the item identifier for the item based on the images. The picker client device 110 may determine the item identifier directly or by transmitting the images to the online system 140. Furthermore, the picker client device 110 determines weights for items that are priced by weight. The picker client device 110 may prompt the picker to manually input the weight of an item or may communicate with a weighing system in the source location to receive the weight of an item.

When the picker has collected the items for an order, the picker client device 110 instructs a picker on where to deliver the items for a user's order. For example, the picker client device 110 displays a delivery location from the order to the picker. The picker client device 110 also provides navigation instructions for the picker to travel from the source location to the delivery location. When a picker is servicing more than one order, the picker client device 110 identifies which items should be delivered to which delivery location. The picker client device 110 may provide navigation instructions from the source location to each of the delivery locations. The picker client device 110 may receive one or more delivery locations from the online system 140 and may provide the delivery locations to the picker so that the picker can deliver the corresponding one or more orders to those locations. The picker client device 110 may also provide navigation instructions for the picker from the source location from which the picker collected the items to the one or more delivery locations.

In some embodiments, the picker client device 110 tracks the location of the picker as the picker delivers orders to delivery locations. The picker client device 110 collects location data and transmits the location data to the online system 140. The online system 140 may transmit the location data to the user client device 100 for display to the user, so that the user can keep track of when their order will be delivered. Additionally, the online system 140 may generate updated navigation instructions for the picker based on the picker's location. For example, if the picker takes a wrong turn while traveling to a delivery location, the online system 140 determines the picker's updated location based on location data from the picker client device 110 and generates updated navigation instructions for the picker based on the updated location.

In some embodiments, the picker is a single person who collects items for an order from a source location and delivers the order to the delivery location for the order. Alternatively, more than one person may serve the role of a picker for an order. For example, multiple people may collect the items at the source location for a single order. Similarly, the person who delivers an order to its delivery location may be different from the person or people who collected the items from the source location. In these embodiments, each person may have a picker client device 110 that they can use to interact with the online system 140.

Additionally, while the description herein may primarily refer to pickers as humans, in some embodiments, some or all of the steps taken by the picker may be automated. For example, a semi- or fully-autonomous robot may collect items in a source location for an order and an autonomous vehicle may deliver an order to a user from a source location.

In one or more embodiments, the online system 140 communicates with a smart shopping cart being used by a user to collect items in a source location. For example, the smart shopping cart may display content received from the online system and may receive data describing items that are collected by the user and stored in a storage area of the shopping cart. In some embodiments, the smart shopping cart is a picker client device 110 being operated by a picker collecting items within a source location. Similarly, the smart shopping cart may be operated by a user within the source location collecting items for themselves. Example embodiments of smart shopping carts are described in U.S. patent application Ser. No. 18/630,672, entitled “Automated Identification of Items Placed in a Cart and Recommendations based on Same,” filed Apr. 9, 2024, which is hereby incorporated by reference in its entirety.

The source computing system 120 is a computing system operated by a source that interacts with the online system 140. As used herein, a “source” is an entity that operates a “source location,” which is a store, warehouse, or any other source from which a picker can collect items. The source computing system 120 stores and provides item data to the online system 140 and may regularly update the online system 140 with updated item data. For example, the source computing system 120 provides item data indicating which items are available at a particular source location and the quantities of those items. Additionally, the source computing system 120 may transmit updated item data to the online system 140 when an item is no longer available at the source location. Additionally, the source computing system 120 may provide the online system 140 with updated item prices, sales, or availabilities.

Additionally, the source computing system 120 may receive payment information from the online system 140 for orders serviced by the online system 140. Alternatively, the source computing system 120 may provide payment to the online system 140 for some portion of the overall cost of a user's order (e.g., as a commission).

The source computing system 120 may generate service requests for the online system 140. A service request from the source computing system 120 may be to, e.g., request to negotiate take rate fees (e.g., fees charged by the online system 140 for use of the online system 140 to sell their items), negotiate some other business related deal with the online system 140, etc. For example, the source computing system 120 may generate a service request that proposes take fees for one or more items, and provides the service request to the online system 140. In some embodiments, the source computing system 120 receives a proposed agreement relating to the service request from the online system 140. The source computing system 120 may present the proposed agreement for approval or disapproval to a user of the source computing system 120. If the user rejects the proposed agreement, the user may provide a reason for the rejection. The source computing system 120 may provide the reason for the rejection to the online system 140 which may have AI agents generate a new proposed agreement based in part on the reason. Once a proposed agreement is approved by the user of the source computing system 120, the source computing system 120 may coordinate with the online system 140 to proceed according to the approved proposed agreement.

The user client device 100, the picker client device 110, the source computing system 120, and the online system 140 can communicate with each other via the network 130. The network 130 is a collection of computing devices that communicate via wired or wireless connections. The network 130 may include one or more local area networks (LANs) or one or more wide area networks (WANs). The network 130, as referred to herein, is an inclusive term that may refer to any or all of the standard layers used to describe a physical or virtual network, such as the physical layer, the data link layer, the network layer, the transport layer, the session layer, the presentation layer, and the application layer. The network 130 may include physical media for communicating data from one computing device to another computing device, such as multiprotocol label switching (MPLS) lines, fiber optic cables, cellular connections (e.g., 3G, 4G, or 5G spectra), or satellites. The network 130 also may use networking protocols, such as TCP/IP, HTTP, SSH, SMS, or FTP, to transmit data between computing devices. In some embodiments, the network 130 may include Bluetooth or near-field communication (NFC) technologies or protocols for local communications between computing devices. The network 130 may transmit encrypted or unencrypted data.

The online system 140 may receive service requests from user devices. The service requests may request different services based in part on the user device. For example, in embodiments where the user device is the user client device 100, the service request may be an ordering list of items that a user of the user client device 100 would like to order. Or in cases where the user device is the source computing system 120, the service request may propose take rates for one or more items that may be offered for sale (via the online system 140) by the source computing system 120.

The online system 140 is an online system that may interact with users of different user devices differently. For example, the online system 140 may interact with users of the user client device 100 in a manner by which users can order items to be provided to them by a picker from a source. The online system 140 may interact with users of the source computing system 120 to, e.g., coordinate regarding pricing for items, take rate fees (e.g., fees charged by the online system 140 for use of the online system 140 to sell their items) for items, etc. The online system 140 may interact with users (e.g., advertisers) to set up advertising campaigns for items. The online system 140 includes a manager for AI messaging 170 and a machine-learning training module 180.

The manager for AI messaging 170 manages messaging of system AI agents 160 with user devices (e.g., user client device 100, the source computing system 120, etc.) and/or the user AI agents 150 (e.g., associated with users of the user devices) to come to resolutions for service requests received from the user devices. The system AI agents 160 negotiate (via the manager of AI messaging 170) on behalf of the online system 140 directly with the user devices and/or the user AI agents 150 to come to resolutions regarding service requests.

Note that in FIG. 1, the user AI agents 150 are illustrated as being part of the online system 140. In other embodiments, some or all of the user AI agents 150 may be part of the user client device 100.

In embodiments, where the resolution is for an order associated with a user of a user client device 100, the online system 140 selects a picker to service the user's order and transmits the order to a picker client device 110 associated with the picker. If the picker accepts the order, the picker collects the ordered items from a source location and delivers the ordered items to the user. The online system 140 may charge a user for the order and provide portions of the payment from the user to the picker and the source. Note that in other embodiments, the user may be a user of, e.g., the source computing system 120 and the resolution may pertain to e.g., take fees for one or more items. In some embodiments, the user may be, e.g., an advertiser and the resolution may be, e.g., information describing an advertisement campaign of the user.

The AI agents of the online system 140 may be trained by the machine-learning training module 180. The user AI agents 150 are associated with different types. A type may describe, e.g., a particular negotiation style, a particular category of user (e.g., user of the user client device 100, use of the source computing system 120, etc.), whether the user AI agent is meant to mimic a user, whether the user AI agent is meant to act on behalf of a user, etc. In some embodiments, each of the user AI agents 150 is a separate large language model that is pre-trained using training user constraints and training user objectives. The type of a user AI agent may be based in part on the set of training user constraints and/or the set of training user objectives that are used in the pre-training of the user AI agent. The training user constraints and/or training user objectives used to train one user AI agent of a particular type, may differ from training user constraints and/or training user objectives used to train a different user AI agent of a different type. In this manner, the user AI agents 150 may be trained by the machine-learning training module 180 to behave in different ways.

The machine-learning training module 180 may pre-train the system AI agents 160 based in part on one or more sets of system constraints and one or more sets of system objectives. And in some embodiments, the machine-learning training module 180 may pre-train the user AI agents 150 using one or more training sets of user constraints and one or more training sets of user objectives. The machine-learning training module 180 may create an instance of a system AI agent that comprises a large language model that has been pre-trained using a set of system constraints and a set of system objectives. The machine-learning training module 180 may instruct the user AI agents 150 to provide training service requests to the manager for AI messaging 170. The manager for AI messaging 170 may manage rounds of messaging between the user AI agents 150 and the system AI agents 160 to achieve resolutions to the training service requests.

The machine-learning training module 180 may generate training examples based in part on the training service requests from the user AI agents 150 and the resolutions to the training service requests. The machine-learning training module 180 may label each training example based on a comparison of a resolution of the training example to a performance metric (e.g., profit of at least a threshold value) of the online system 140. The machine-learning training module 180 may train the system AI agents 160 using the labeled training examples. In some embodiments, the machine-learning training module 180 may also train one or more of the user AI agents 150 based in part on the training examples (e.g., labeled based on a comparison of a resolution of the training example to a performance metric associated with the user AI agent).

In the above manner, the system AI agents 160 may be trained to interact with a user AI agents 150 of different types. In some embodiments, a single system AI agent is trained in this manner using some or all of the user AI agents 150. In other embodiments, the machine-learning training module 180 may train a plurality of system AI agents (e.g., each system AI agent is trained using a different user AI agent of a different type). Note that the system AI agents 160 may be trained across a variety of types of user AI agents 150. As such, the machine-learning training module 180 may train in an adversarial manner, the system AI agents 160 to handle a variety of different users, negotiation tactics, negotiations with a user of a user device, negotiations with a user AI agent acting on behalf of a user of a user device, etc.

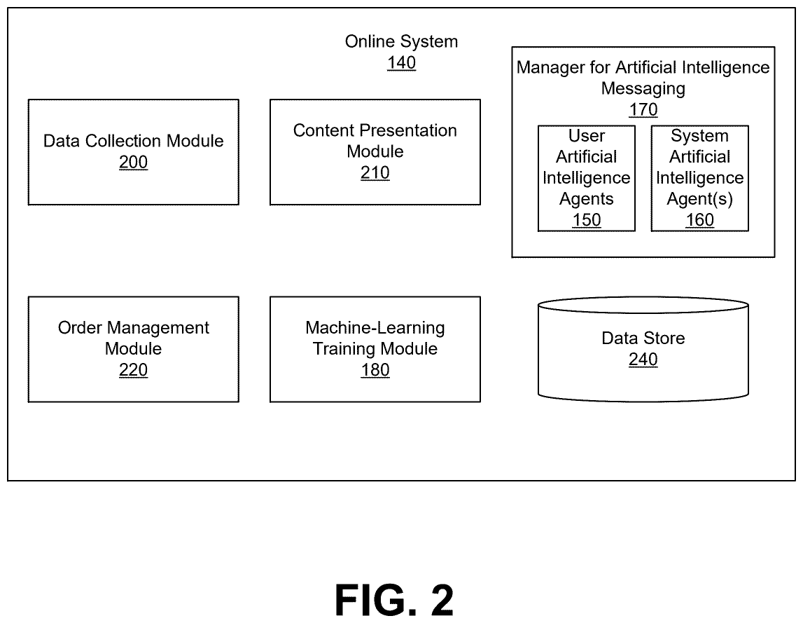

Note that after the trained system AI agents 160 have been deployed for use with users of the online system 140, the machine-learning training module 180 may continue to train the system AI agents 160 using data obtained as the online system 140 responds to service requests. The online system 140 is described in further detail below with regards to FIG. 2.

FIG. 2 illustrates an example system architecture for an online system 140, in accordance with some embodiments. The system architecture illustrated in FIG. 2 includes a data collection module 200, a content presentation module 210, the manager for AI messaging 170, an order management module 220, the machine-learning training module 180, and a data store 240. Alternative embodiments may include more, fewer, or different components from those illustrated in FIG. 2, and the functionality of each component may be divided between the components differently from the description below. Additionally, each component may perform their respective functionalities in response to a request from a human, or automatically without human intervention.

The data collection module 200 collects data used by the online system 140 and stores the data in the data store 240. In preferred embodiments, the data collection module 200 only collects data describing a user if the user has previously explicitly consented to the online system 140 collecting data describing the user. Additionally, the data collection module 200 may encrypt all data, including sensitive or personal data, describing users.

For example, the data collection module 200 collects user data, which is information or data that describe characteristics of a user. User data may include a user's name, address, shopping preferences, favorite items, stored payment instruments, prior order histories (e.g., what items were ordered, from which sources, prices paid, etc.). The user data also may include default settings established by the user, such as a default source/source location, payment instrument, delivery location, or delivery timeframe. The data collection module 200 may collect the user data from sensors on the user client device 100 or based on the user's interactions with the online system 140.

The data collection module 200 also collects item data, which is information or data that identifies and describes items that are available at a source location. The item data may include item identifiers for items that are available and may include quantities of items associated with each item identifier. Additionally, item data may also include attributes of items such as the size, color, weight, stock keeping unit (SKU), or serial number for the item. Item data may also include pricing information. The pricing information may include a price for an item, discounts associated with items, take rate fee, ad impression fee, etc. The item data may further include purchasing rules associated with each item, if they exist. For example, age-restricted items such as alcohol and tobacco are flagged accordingly in the item data. Item data may also include information that is useful for predicting the availability of items in source locations. For example, for each item-source combination (a particular item at a particular warehouse), the item data may include a time that the item was last found, a time that the item was last not found (a picker looked for the item but could not find it), the rate at which the item is found, or the popularity of the item. The data collection module 200 may collect item data from a source computing system 120, a picker client device 110, or the user client device 100.

An item category is a set of items that are a similar type of item. Items in an item category may be considered to be equivalent to each other or may be substitutes for each other in an order. For example, different brands of sourdough bread may be different items, but these items may be in a “sourdough bread” item category. The item categories may be human-generated and human-populated with items. The item categories also may be generated automatically by the online system 140 (e.g., using a clustering algorithm).

The data collection module 200 also collects picker data, which is information or data that describes characteristics of pickers. For example, the picker data for a picker may include the picker's name, the picker's location, how often the picker has serviced orders for the online system 140, a user rating for the picker, which sources the picker has collected items at, or the picker's previous shopping history. Additionally, the picker data may include preferences expressed by the picker, such as their preferred sources to collect items at, how far they are willing to travel to deliver items to a user, how many items they are willing to collect at a time, timeframes within which the picker is willing to service orders, or payment information by which the picker is to be paid for servicing orders (e.g., a bank account). The data collection module 200 collects picker data from sensors of the picker client device 110 or from the picker's interactions with the online system 140.

Additionally, the data collection module 200 collects order data, which is information or data that describes characteristics of an order. For example, order data may include item data for items that are included in the order, a delivery location for the order, a user associated with the order, a source location from which the user wants the ordered items collected, or a timeframe within which the user wants the order delivered. Order data may further include information describing how the order was serviced, such as which picker serviced the order, when the order was delivered, or a rating that the user gave the delivery of the order. In some embodiments, the order data includes user data for users associated with the order, such as user data for a user who placed the order or picker data for a picker who serviced the order.

While user data, picker data, source data, item data, and order data are described separately, data collected by the data collection module 200 may fall into more than one of these categories. For example, data describing a picker's performance for an order may be order data and picker data.

The data collection module 200 may collect messaging data. Messaging data describes aspects of negotiations between a system AI agent (e.g., the system AI agent 160) and other entities (e.g., the user AI agents 150 and/or user devices). For example, messaging data may describe for a given messaging session (e.g., between a system AI agent, and a user device or user AI agent): a training service request, a service request, items proposed by a system AI agent, rejections by a user AI agent, feedback (e.g., rejection, approval, reason for rejection) from a user of a user device, reasons for the rejections by the user AI agent, output messages from user AI agent, output messages from system AI agent, incentives requested by the user AI agent, incentives proposed by the system AI agent, incentives accepted by the user AI agent, a number of times a user provided feedback during the negotiation, user constraints for one or more types of user AI agents, user objectives for one or more types of user AI agents, system constraints for one or more types of system AI agents, system objectives for one or more system AI agents, proposed agreement to resolve the service request, a resolution to the service request, some other information describing the negotiation, timing data on how long it took for a response, whether a user opened or closed the application during the messaging session, or some combination thereof.

The content presentation module 210 selects content for presentation to a user. For example, the content presentation module 210 selects which items to present to a user while the user is placing an order. The content presentation module 210 generates and transmits an ordering interface for the user to order items. The content presentation module 210 populates the ordering interface with items that the user may select for adding to their order. In some embodiments, the content presentation module 210 presents a catalog of all items that are available to the user, which the user can browse to select items to order. The content presentation module 210 also may identify items that the user is most likely to order and present those items to the user. For example, the content presentation module 210 may score items and rank the items based on their scores. The content presentation module 210 displays the items with scores that exceed some threshold (e.g., the top n items or the p percentile of items).

The content presentation module 210 may use an item selection model to score items for presentation to a user. An item selection model is a machine-learning model that is trained to score items for a user based on item data for the items and user data for the user. For example, the item selection model may be trained to determine a likelihood that the user will order the item. In some embodiments, the item selection model uses item embeddings describing items and user embeddings describing users to score items. These item embeddings and user embeddings may be generated by separate machine-learning models and may be stored in the data store 240.

In some embodiments, the content presentation module 210 scores items based on a search query received from the user client device 100. A search query is free text for a word or set of words that indicate items of interest to the user. The content presentation module 210 scores items based on a relatedness of the items to the search query. For example, the content presentation module 210 may apply natural language processing (NLP) techniques to the text in the search query to generate a search query representation (e.g., an embedding) that represents characteristics of the search query. The content presentation module 210 may use the search query representation to score candidate items for presentation to a user (e.g., by comparing a search query embedding to an item embedding).

In some embodiments, the content presentation module 210 scores items based on a predicted availability of an item. The content presentation module 210 may use an availability model to predict the availability of an item. An availability model is a machine-learning model that is trained to predict the availability of an item at a particular source location. For example, the availability model may be trained to predict a likelihood that an item is available at a source location or may predict an estimated number of items that are available at a source location. The content presentation module 210 may apply a weight to the score for an item based on the predicted availability of the item. Alternatively, the content presentation module 210 may filter out items from presentation to a user based on whether the predicted availability of the item exceeds a threshold.

The manager for AI messaging 170 manages messaging of system AI agents 160 with user devices (e.g., user client device 100, the source computing system 120, etc.) and/or the user AI agents 150 (e.g., acting on behalf of users of the user devices, for training the system AI agents) to come to resolutions for service requests and/or training service requests. The system AI agents 160 negotiate (via the manager of AI messaging 170) on behalf of the online system 140 to come to a resolution regarding service requests (and training service requests). In some embodiments, the system AI agent 160 negotiates (via the manager of AI messaging 170) with one of the user AI agents 150 to determine a resolution for a service request. In other embodiments, the system AI agent 160 negotiates (via the manager of AI messaging 170) with a user device to come to the resolution. In some embodiments, there is a single system AI agent that negotiates with user devices and/or the user AI agents 150. In other embodiments, the manager for AI messaging 170 manages a plurality of system AI agents. For example, each of the system AI agents may be trained to negotiate using different negotiation tactics, with a different set of objectives or constraints, or with different user categories.

In one or more embodiments, each system AI agent (or a user AI agent) maintains an internal state that indicates an assessment of the likelihood of success (according to a set of objectives) or otherwise an expected outcome of the messaging session between the agents. The system 140 keeps track of these assessments and uses them to select which system AI agent should continue the conversation with the user AI agent. For example, one system AI agent may be specifically trained on users who are at risk of churning (e.g., not using the system for a period of time), whereas another system AI agent may be specifically trained to surface high quality options to the users. The system could decide to switch to the first system AI agent if the user AI agent shows signs of abandoning the conversation. In another example, a machine learning model is trained to predict which system AI agent has the highest expected outcome (of a predetermined system metric, such as likelihood of a conversion). This model could be trained, for example, by initially randomizing which system AI agent to use and then observing the outcome to be predicted. This model is then used during the instantiation phase to select which system AI agent is most likely to maximize the predicted outcome.

The manager for AI messaging 170 may create one or more instances of a user AI agent (e.g., of the user AI agents 150). The user AI agent has been trained using a set of user constraints and/or a set of user objectives. Some or all of the set of user objectives and/or some or all of the set of user constraints may be provided by the user client device 100. User constraints are restrictions that a user AI agent representing interests of a user abides by while negotiating a resolution for a service request. User objectives are goals that the user AI agent attempts to achieve while negotiating the order with a system AI agent. User constraints may include, e.g., maximum budget, time items are to be delivered by, allowing substitutions for items, minimum number of ad impressions, maximum price user pays for ad impression for an item, a maximum take rate fee for an item, etc. User objectives may include, e.g., source location, minimizing number of substitute items, having a delivery time within a threshold period of time of a requested delivery time, take rate fee below a maximum take rate fee for an item, price below maximum price user pays for ad impression for an item, etc. Note in some embodiments, a user objective can also be a user constraint. In this context, training user objectives and training user constraints are user objectives and user constraints that are used to train the user AI agents.

In some embodiments, the user AI agents 150 (e.g., each represent a different negotiation style) are used to train the system AI agents 160. The trained system AI agents 160 may then negotiate directly with user devices to come to resolutions regarding service orders. In some embodiments, the user AI agents 150 may be used to train the system AI agents 160 and to negotiate on behalf of users of user devices with the system AI agents 160 regarding service requests. For example, the manager for AI messaging 170 may create an instance of the user AI agent responsive to receiving a service request from a user client device 100. In some embodiments, the system AI agents 160 may be trained to negotiate directly with user devices to come to resolutions regarding service orders, and to negotiate with the user AI agents 150 to come to resolutions regarding service orders.

The manager for AI messaging 170 may create one or more instances of the system AI agents 160. For example, the manager for AI messaging 170 may create an instance of a system AI agent responsive to receiving the service request from the user client device 100. The system AI agent may be a large language model that has been trained using a set of system constraints and/or a set of system objectives. System constraints and system objectives control in part how a system AI agent negotiates on behalf of the online system 140 with the user AI agents 150 and/or user devices (e.g., the user client device 100, the source computing system 120, etc.). System constraints are restrictions that a system AI agent abides by while negotiating on behalf of the online system 140 with the user AI agents 150 and/or user devices. And system objectives are goals that a system AI agent attempts to achieve while negotiating on behalf of the online system 140 with the user AI agents 150 and/or user devices. System constraints may include, e.g., available pickers, minimum profit per transaction, available inventory, available item discounts, minimum ad impression fee for an item, minimum take rate fee for an item, etc. System objectives may include, e.g., a profit per transaction, having a number of content or ad impressions for items from the online catalog, a number level of content or ad impressions for sponsored items from the online catalog, a level of user satisfaction (e.g., selecting items that are requested by the user), assisting sources in turning over inventory, a take rate fee for an item, ad impression fees, etc.

In embodiments, where the user AI agents 150 are used to negotiate on behalf of users, the manager for AI messaging 170 prompts at least one of a user AI agent and a system AI agent to generate a message to the online system 140 based on a received service request. The prompt may be to prepare an initial offer that would satisfy the service request. The initial offer describes details of proposal (e.g., a proposed order for items, proposed take rate fee, etc.) based on the received service request.

The manager for AI messaging 170 manages one or more rounds of messaging between the user AI agent and the system AI agent. For example, in some embodiments, the manager for AI messaging 170 may apply the prompt to the user AI agent, causing the user AI agent to generate an output message. The output message describes a proposal (e.g., proposed order) that is based in part on the service request, and satisfies one or more of the user objectives and/or one or more of the user constraints. The prompt may cause the user AI agent to evaluate the service request to determine a proposal (e.g., an initial set of one or more items that are part of the online catalog) in a manner that satisfies one or more user objectives and/or one or more user constraints.

The manager for AI messaging 170 may prompt the system AI agent based on the output message from the user AI agent. In some embodiments, the manager for AI messaging 170 may generate a prompt based in part on the output message from the user AI agent. The manager for AI messaging 170 may apply the prompt to the system AI agent.

The prompt may cause the system AI agent to evaluate the service request and some or all of the output message to determine whether the proposal would satisfy the service request and one or more of the set of system objectives and/or one or more of the set of system constraints, and if not, generate a counteroffer. The output message generated by the system AI agent may approve some or all of the proposal or reject some or all of it. In cases where the system AI agent rejects at least some of the proposal, the system AI agent may determine a counteroffer. The counteroffer may include, e.g., one or more incentives, one or more substitute items, etc. The system AI agent may generate an output message including the counteroffer.

In cases where the system AI agent generates a counteroffer, a counteroffer describes a proposal that satisfies one or more of the set of system objectives and/or one or more of the set of system constraints but differs from the received proposal. Note, in embodiments where an item is requested in the service request and the counteroffer proposes some other item (referred to as a substitute item) as a substitute, the counteroffer may also include a reason (e.g., lower price, earlier delivery time, etc.) for the proposed substitution. The manager for AI messaging 170 may prompt the user AI agent based on the output message (e.g., including the counteroffer) from the system AI agent.

The output message generated by the user AI agent may approve some or all of the proposal of the system AI agent or reject some or all of it. In cases where the user AI agent rejects at least some of the proposal, the user AI agent may determine a counteroffer. In cases where the user AI agent generates a counteroffer, a counteroffer describes a proposal that satisfies one or more of the set of user objectives and/or one or more of the set of user constraints but differs from the received proposal. The manager for AI messaging 170 may prompt the system AI agent based on the output message (e.g., including the counteroffer) from the user AI agent.

The back and forth between the user AI agent and the system AI agent via the manager for AI messaging 170 may continue until a proposed agreement that is based in part on the service request is achieved. The manager for AI messaging 170 extracts, from the messaging between the user AI agent and the system AI agent, the proposed agreement between the user associated with the service request and the online system 140. For example, the manager for AI messaging 170 may extract a proposed agreement after a proposal based on the service request is approved by both the system AI agent and the user AI agent. The proposal may cover, e.g., items for purchase, pricing for items, delivery time, delivery location, source for the items, incentives (that would be applied to the order and/or a future order), assigned pickers, take rate fees, advertising campaign details (e.g., ad impression fees), some other aspect of an order, or some combination thereof.

The manager for AI messaging 170 outputs the proposed agreement to one or more of the user device or the online system 140. The online system 140 may receive feedback on the proposed agreement from the user device. For example, the feedback may be approval of the proposed agreement by the user of the user device. Alternatively, the feedback may be a rejection of the proposed agreement, and the feedback may include one or more reasons for the rejection. The manager for AI messaging 170 may negotiate a new proposed agreement based in part on the feedback from the user, and provide the new proposed agreement to the user device. The back and forth between the user AI agent and the system AI agent may occur until the user AI agent approves a proposed agreement (or it is cancelled by the user AI agent and/or the system AI agent). Once a proposed agreement is approved, the system AI agent has a resolution to the service request, and the online system 140 proceeds in accordance with the proposed agreement. In some embodiments, the user AI agent may be authorized to approve the online system 140 to proceed in accordance with a proposed agreement without express approval by the user.

In the above manner, a system AI agent negotiates with a user AI agent to determine a resolution. In other embodiments, a system AI agent negotiates directly with a user device. For example, the manager for AI messaging 170 may receive a service request from a user device associated with a user. The manager for AI messaging 170 may retrieve from the data store 240 information (e.g., user data) about previous interactions of the user with the online system 140. The manager for AI messaging 170 may prompt the system AI agent to determine a proposed agreement based in part on the service request and the information about previous interactions of the user with the online system 140.

The manager for AI messaging 170 may output the proposed agreement to one or more of the user device or the online system 140. The online system 140 may receive feedback on the proposed agreement from the user device. In embodiments where a rejection is received, the manager for AI messaging 170 may prompt the system AI agent to determine a new proposed agreement based in part on the feedback, the service request and the information about previous interactions of the user with the online system 140. Once a proposed agreement is approved, the system AI agent has a resolution to the service request, and the online system 140 proceeds in accordance with the proposed agreement.

The order management module 220 manages orders for items from users. The order management module 220 receives orders from a user client device 100 (e.g., as negotiated and agreed upon between the system AI agent 160 and s user AI agent or as negotiated and agreed upon between the system AI agent 160 and the user client device 100) and offers the orders to pickers for service based on picker data. For example, the order management module 220 offers an order to a picker based on the picker's location and the location of the source from which the ordered items are to be collected. The order management module 220 may also offer an order to a picker based on how many items are in the order, a vehicle operated by the picker, the delivery location, the picker's preferences on how far to travel to deliver an order, the picker's ratings by users, or how often a picker agrees to service an order.

In some embodiments, the order management module 220 determines when to offer an order to a picker based on a delivery timeframe requested by the user with the order and/or as agreed between a user AI agent and the system AI agent 160. The order management module 220 computes an estimated amount of time that it would take for a picker to collect the items for an order and deliver the ordered items to the delivery location for the order. The order management module 220 offers the order to a picker at a time such that, if the picker immediately accepts and services the order, the picker is likely to deliver the order at a time within the requested timeframe. Thus, when the order management module 220 receives an order, the order management module 220 may delay offering the order to a picker if the requested timeframe is far enough in the future (i.e., the picker may be offered the order at a later time and is still predicted to meet the requested timeframe).

When the order management module 220 offers an order to a picker, the order management module 220 transmits the order to the picker client device 110 associated with the picker. The order management module 220 may also transmit navigation instructions from the picker's current location to the source location associated with the order. If the order includes items to collect from multiple source locations, the order management module 220 identifies the source locations to the picker and may also specify a sequence in which the picker should visit the source locations.

The order management module 220 may track the location of the picker through the picker client device 110 to determine when the picker arrives at the source location. When the picker arrives at the source location, the order management module 220 transmits the order to the picker client device 110 for display to the picker. As the picker uses the picker client device 110 to collect items at the source location, the order management module 220 receives item identifiers for items that the picker has collected for the order. In some embodiments, the order management module 220 receives images of items from the picker client device 110 and applies computer-vision techniques to the images to identify the items depicted by the images. The order management module 220 may track the progress of the picker as the picker collects items for an order and may transmit progress updates to the user client device 100 that describe which items have been collected for the user's order.

In some embodiments, the order management module 220 tracks the location of the picker within the source location. The order management module 220 uses sensor data from the picker client device 110 or from sensors in the source location to determine the location of the picker in the source location. The order management module 220 may transmit, to the picker client device 110, instructions to display a map of the source location indicating where in the source location the picker is located. Additionally, the order management module 220 may instruct the picker client device 110 to display the locations of items for the picker to collect, and may further display navigation instructions for how the picker can travel from their current location to the location of the next item to collect for an order.

The order management module 220 determines when the picker has collected the items for an order. For example, the order management module 220 may receive a message from the picker client device 110 indicating that all of the items for an order have been collected. Alternatively, the order management module 220 may receive item identifiers for items collected by the picker and determine when all of the items in an order have been collected. When the order management module 220 determines that the picker has completed an order, the order management module 220 transmits the delivery location for the order to the picker client device 110. The order management module 220 may also transmit navigation instructions to the picker client device 110 that specify how to travel from the source location to the delivery location, or to a subsequent source location for further item collection. The order management module 220 tracks the location of the picker as the picker travels to the delivery location for an order, and updates the user with the location of the picker so that the user can track the progress of the order. In some embodiments, the order management module 220 computes an estimated time of arrival of the picker at the delivery location and provides the estimated time of arrival to the user.

In some embodiments, the order management module 220 facilitates communication between the user client device 100 and the picker client device 110. As noted above, a user may use a user client device 100 to send a message to the picker client device 110. The order management module 220 receives the message from the user client device 100 and transmits the message to the picker client device 110 for presentation to the picker. The picker may use the picker client device 110 to send a message to the user client device 100 in a similar manner.

The order management module 220 coordinates payment by the user for the order. The order management module 220 uses payment information provided by the user (e.g., a credit card number or a bank account) to receive payment for the order. In some embodiments, the order management module 220 stores the payment information for use in subsequent orders by the user. The order management module 220 computes the total cost for the order and charges the user that cost. The order management module 220 may provide a portion of the total cost to the picker for servicing the order, and another portion of the total cost to the source.

The machine-learning training module 180 trains large language models used by the online system 140. For example, the machine-learning training module 180 may be used to train the system AI agents 160 and the user AI agents 150. The online system 140 may use machine-learning models (e.g., large language models) to perform functionalities described herein. Example machine-learning models include regression models, support vector machines, naïve Bayes, decision trees, k nearest neighbors, random forest, boosting algorithms, k-means, and hierarchical clustering. The machine-learning models may also include neural networks, such as perceptrons, multilayer perceptrons, convolutional neural networks, recurrent neural networks, sequence-to-sequence models, generative adversarial networks, transformers, large-language models, or multi-modal large language models. A machine-learning model may include components relating to these different general categories of model, which may be sequenced, layered, or otherwise combined in various configurations. While the term “machine-learning model” may be broadly used herein to refer to any kind of machine-learning model, the term is generally limited to those types of models that are suitable for performing the described functionality. For example, certain types of machine-learning models can perform a particular functionality based on the intended inputs to, and outputs from, the model, the capabilities of the system on which the machine-learning model will operate, or the type and availability of training data for the model.

Each machine-learning model includes a set of parameters. The set of parameters for a machine-learning model are parameters that the machine-learning model uses to process an input to generate an output. For example, a set of parameters for a linear regression model may include weights that are applied to each input variable in the linear combination that comprises the linear regression model. Similarly, the set of parameters for a neural network may include weights and biases that are applied at each neuron in the neural network. The machine-learning training module 180 generates the set of parameters (e.g., the particular values of the parameters) for a machine-learning model by “training” the machine-learning model. Once trained, the machine-learning model uses the set of parameters to transform inputs into outputs.

The machine-learning training module 180 may pre-train the system AI agents 160 using one or more sets of system constraints and one or more sets of system objectives. In some embodiments, the machine-learning training module 180 trains a single system AI agent using a set of system constraints and a set of system objectives. In some embodiments, the machine-learning training module 180 trains multiple system AI agents, where each system AI agent is pre-trained with a corresponding set of system constraints and set of system objectives (which may differ from those used to pre-train other system AI agents).

The machine-learning training module 180 may pre-train the user AI agents 150 using one or more training sets of user constraints and one or more training sets of user objectives. The user AI agents 150 are each associated with a respective type, where the type is based in part on the training set of user constraints and the training set of user objectives used to train it. In this manner, each of the user AI agents 150 may be pre-trained to negotiate in a particular manner and/or mimic a particular category of user (e.g., shopper, advertiser, retailer, etc.).

The machine-learning training module 180 trains a large language model (e.g., a machine-learning model, like, e.g., the user AI agents 150 and the system AI agents 160) based on a set of training examples. Each training example includes input data to which the machine-learning model is applied to generate an output. For example, each training example may include user data (e.g., prior order histories, user preferences, etc.), picker data, item data, order data, or messaging data, which may be referred to respectively as, training user data, training picker data, training item data, training order data, and training messaging data. In some cases, the training examples also include a label which represents an expected output of the machine-learning model. In these cases, the machine-learning model is trained by comparing its output from the input data of a training example to the label for the training example. In general, during training with labeled data, the set of parameters of the model may be set or adjusted to reduce a difference between the output for the training example (given the current parameters of the model) and the label for the training example.

The machine-learning training module 180 may use adversarial training to train the system AI agents 160 using the user AI agents 150. The machine-learning training module 180 may create an instance of a system AI agent (e.g., that has been pre-trained). The machine-learning training module 180 may create instances of the user AI agents 150. The machine-learning training module 180 may instruct the user AI agents 150 to provide training service requests to the manager for AI messaging 170. The manager for AI messaging 170 may manage rounds of messaging between the user AI agents 150 and the system AI agents 160 to achieve resolutions to the training service requests.

The machine-learning training module 180 may generate training examples based in part on the training service requests from the user AI agents 150 and the resolutions to the training service requests. For example, a training example may include some messaging data associated with a training service request (e.g., information describing at least one round of messaging in response to the training service request, a resolution to the training service request, etc.). The machine-learning training module 180 may label each training example based on a comparison of a resolution of the training example to one or more performance metrics of the online system 140. The performance metric may be based in part on a type of the user AI agent that is training the system AI agents 160. For example, if the type of the user AI agent associated with the resolution is a user of the user client device 100, the performance metric may be, e.g., profit of at least a threshold value. In contrast, if the type of the user AI agent associated with the resolution is a retailer, some other performance metric may be used. Performance metrics may include, e.g., number of messaging rounds till resolution was achieved, profit made on transaction, to what extent system objectives were met and/or exceeded, etc.

The machine-learning training module 180 may apply an iterative process to train a machine-learning model whereby the machine-learning training module 180 updates parameter values of the machine-learning model based on each of the set of training examples. The training examples may be processed together, individually, or in batches. To train a machine-learning model based on a training example, the machine-learning training module 180 applies the machine-learning model to the input data in the training example to generate an output based on a current set of parameter values. The machine-learning training module 180 scores the output from the machine-learning model using a loss function. A loss function is a function that generates a score for the output of the machine-learning model such that the score is higher when the machine-learning model performs poorly and lower when the machine-learning model performs well. In cases where the training example includes a label, the loss function is also based on the label for the training example. Some example loss functions include the mean square error function, the mean absolute error, hinge loss function, and the cross entropy loss function. The machine-learning training module 180 updates the set of parameters for the machine-learning model based on the score generated by the loss function. For example, the machine-learning training module 180 may apply gradient descent to update the set of parameters.

The machine-learning training module 180 trains the system AI agents 160 based on negotiations with the user AI agents 150. The machine-learning training module 180 may train the system AI agents 160 using the labeled training examples. The machine-learning training module 180 may access a set of training examples (e.g., labeled training examples), each training example including at least training messaging data, but also may include, e.g., training picker data, training item data, training order data, training user data, or some combination thereof. The machine-learning training module 180 may apply a system AI agent to the set of training examples to generate a training output. The machine-learning training module 180 may generate a labeled training example by evaluating the training output against the set of system objectives or the set of system constraints. The machine-learning training module 180 may update the large language model associated with the system AI agent using the labeled training examples.

In some embodiments, in a similar manner, the machine-learning training module 180 may also train one or more of the user AI agents 150 based in part on the training examples (e.g., labeled based on a comparison of a resolution of the training example to a performance metric associated with the user AI agent).

In some embodiments, the machine-learning training module 180 may retrain a machine-learning model based on the actual performance of the system AI agents 160 (and in some embodiments, the user AI agents 150) after the online system 140 has deployed the system AI agents 160 (and in some embodiments, the user AI agents 150) to provide service to users. For example, if the machine-learning model is used to predict a likelihood of an outcome of an event, the online system 140 may log the prediction and an observation of the actual outcome of the event. Alternatively, if the machine-learning model is used to classify an object, the online system 140 may log the classification as well as a label indicating a correct classification of the object (e.g., following a human labeler or other inferred indication of the correct classification). After sufficient additional training data has been acquired, the machine-learning training module 180 retrains the machine-learning model using the additional training data, using any of the methods described above. This deployment and retraining process may be repeated over the lifetime use for the machine-learning model. This way, the machine-learning model continues to improve its output and adapts to changes in the system environment, thereby improving the functionality of the online system 140 as a whole in its performance of the tasks described herein. In this manner, one or more system AI agents (and in some embodiments one or more user AI agents) may be retrained.

For example, the machine-learning training module 180 may generate additional training examples based on one or more previous service requests from users, each training example including messaging data (e.g., resolutions, service requests, etc.), and may also include user data (e.g., information about previous interactions of the user with the online system), order data, item data, picker data, or some combination thereof. The machine-learning training module 180 may label the additional training examples based on comparisons of the resolutions of the additional training examples to one or more metrics associated with the online system 140. The machine-learning training module 180 may retrain the system AI agents 160 and/or the user AI agents 150 using the additional training examples.

The data store 240 stores data used by the online system 140. For example, the data store 240 stores user data, item data, order data, messaging data, system constraints, system objectives, training user constraints, training user objectives, and picker data for use by the online system 140. In some embodiments, the data store 240 may also store user constraints and user objectives. The data store 240 also stores trained machine-learning models (e.g., the system AI agents 160, and the user AI agents 150) trained by the machine-learning training module 180. For example, the data store 240 may store the set of parameters for a trained machine-learning model on one or more non-transitory, computer-readable media. The data store 240 uses computer-readable media to store data, and may use databases to organize the stored data.

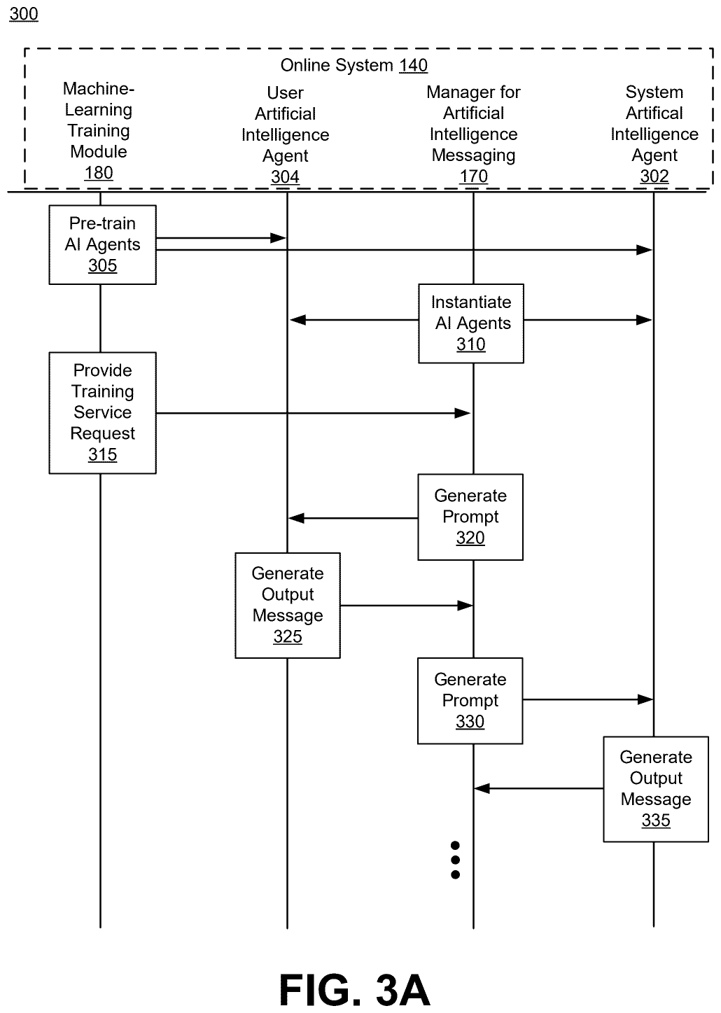

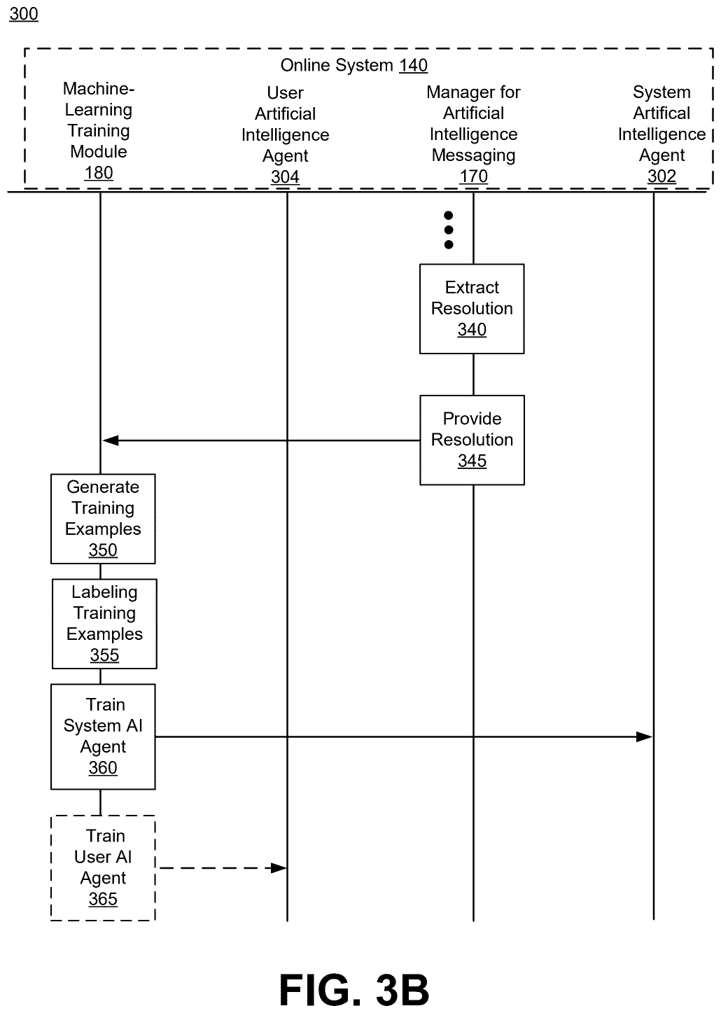

FIGS. 3A-B is an example sequence diagram 300 describing adversarial training of a system AI agent 302 using a user AI agent 304, in accordance with some embodiments. The system AI agent 302 is an embodiment of the system AI agents 160, and the user AI agent 304 is one of the user AI agents 150. Alternative embodiments may include more, fewer, or different interactions from those illustrated in FIGS. 3A-B, and the steps may be performed in a different order from that illustrated in FIGS. 3A-B.

The machine learning training module 180 pre-trains 305 the user AI agent 304 and the system AI agent 302. The machine-learning training module 180 may retrieve a set of system objectives, a set of system constraints, a set of training user objectives, and a set of training user constraints from a data store (e.g., the data store 240). The machine-learning training module 180 pre-trains the system AI agent 302 using the set of system constraints and the set of system objectives. The machine-learning training module 180 pre-trains the user AI agent 304 using the training set of user constraints and the training set of user objectives. The user AI agent 304 is associated with a type, where the type is based in part on the training set of user constraints and the training set of user objectives. In this manner, the user AI agent 304 is pre-trained to, e.g., negotiate in a particular manner and/or mimic a particular category of user (e.g., shopper, advertiser, retailer, etc.).

The manager for the AI messaging 170 of the online system 140 instantiates 310 the user AI agent 304 and the system AI agent 302.

The machine-learning training module 180 provides 315 a training service request to the manager for AI messaging 170. The machine-learning training module 180 may retrieve the training service request from the data store 240. The training service request is one of a plurality of training service requests that are used in the training of the system AI agent 302 to prepare it for deployment in a real-world setting.

The manager for the AI messaging 170 generates 320 a prompt based in part on the training service request. The prompt instructs the user AI agent 304 to generate an output message that is based in part on the service request. The output message may be, e.g., an initial offer that describes details (e.g., items, pricing, delivery time, delivery location, take rate fee, etc.) of a proposal based on the received service request.

In the illustrated embodiment, the prompt is applied (e.g., by the manager for the AI messaging 170) to the user AI agent 304, causing the user AI agent 304 to generate 325 an output message. The user AI agent 304 evaluates the service request to generate a proposal (e.g., one or more items that are part of the online catalog and that satisfy one or more the set of user objectives and the set of user constraints). The output message is provided to the manager for the AI messaging 170.

The manager for the AI messaging 170 generates 330 a prompt based in part on the output message from the user AI agent 304. For example, the prompt may instruct the system AI agent 302 to evaluate the training service request and some or all of the output message to determine whether the proposal would satisfy the service request and one or more system objectives and the set of system constraints, and if not, generate a counteroffer. In some embodiments, the prompt may instruct the system AI agent 302 to consider a discount requested by the user AI agent 304 based on some or all of the set of system objectives and/or some or all of the set of system constraints.

The prompt is applied (e.g., by the manager for the AI messaging 170) to the system AI agent 302, causing the system AI agent 302 to generate 335 an output message. The prompt may cause the system AI agent 302 to evaluate the training service request and some or all of the output message to determine whether the proposal from the user AI agent 304 would satisfy the training service request and one or more of the set of system objectives and the set of system constraints, and if not, generate a counteroffer.

The output message generated by the system AI agent 302 may approve some or all of the proposal from the user AI agent 304 or reject some or all of the proposal from the user AI agent 304. In cases where the system AI agent 302 rejects at least some of the proposal, the system AI agent 302 may determine a counteroffer. The counteroffer may include, e.g., one or more incentives, one or more substitute items, adjusted rate take fee, etc. Note, in embodiments where an item is requested in a proposal from the user AI agent 304, and the system AI agent 302 in the counteroffer proposes some other item (i.e., as substitute item) as a substitute, the system AI agent 302 may also include a reason for the proposed substitution (e.g., lower price, earlier delivery time, etc.). Likewise, in some embodiments, if the system AI agent 302 rejects an item of a proposal from the user AI agent 304, the system AI agent 302 may provide a reason for the rejection in the output message. And the manager for the AI messaging 170 may prompt the user AI agent 304 to respond to the reason for the rejection based on the set of user objectives or the set of user constraints. In some embodiments, rejections may be addressed item by item. Or in other embodiments, a rejection of the order may be evaluated in view of the proposed order as a whole.

The back and forth between the user AI agent 304 and the system AI agent 302 via the manager for AI messaging 170 may continue until a resolution that is based in part on the service request is achieved. The manager for AI messaging 170 extracts 340, from the messaging between the user AI agent 304 and the system AI agent 302, a resolution describing an agreement between the user AI agent 304 and the system AI agent 302. The manager for AI messaging 170 may extract a resolution once a proposal based on the service request is approved by both the system AI agent 302 and the user AI agent 304. The resolution may cover, e.g., items for purchase, pricing for items, delivery time, delivery location, source for the items, incentives (that would be applied to the order and/or a future order), take rate fees, ad impression fees, etc.

The manager for AI messaging 170 provides 345 the resolution to the machine-learning training module 180. Steps 315-345 repeat a plurality of times (possibly hundreds, thousands, millions, or more) for different training service requests.

Note that in the illustrated embodiment, the manager for AI messaging 170 first generates 320 the prompt for the user AI agent 304. In other embodiments, the manager for AI messaging 170 first generates 320 the prompt for the system AI agent 302. Regardless of which AI agent is prompted first, the manager for AI messaging 170 may manage the resulting one or more rounds of messaging between the user AI agent 304 and the system AI agent 302 to obtain a resolution to the training service request.

The machine-learning training module 180 generates 350 training examples. The training examples are based in part on the training service requests from the user AI agent 304 and the resolutions to the training service requests. For example, a training example, may include at least training messaging data, but also may include, e.g., training picker data, training item data, training order data, training user data, or some combination thereof.

The machine-learning training module 180 labels 355 some or all of the training examples. The labeling may be based on a comparison of a resolution of a training example to one or more performance metrics of the online system 140. The performance metric may be based in part on a type of the user AI agent 304 that is training the system AI agent 302.

The machine-learning training module 180 trains 360 the system AI agent 302 using some or all of the labeled training examples. In some embodiments, the machine-learning training module 180 also trains 365 the user AI agent 304 using the training examples. The machine-learning training module 180 may label each training example based on a comparison of a resolution of the training example to one or more performance metrics of the user AI agent 304. The performance metric may be based in part on, e.g., how effective the user AI agent 304 was in meeting the set of user objectives and the set of user constraints.

In the above manner, the system AI agent 302 can be trained in an adversarial manner to negotiate with a user AI agent of a particular type (e.g., the user AI agent 304). The online system 140 may use a same or similar process to that described in FIGS. 3A-3B to train the system AI agent 302 to negotiate with user AI agents of different types. For example, the online system 140 may perform steps 310-360 for different user AI agents, such that the system AI agent 302 is trained using the user AI agent 304 as well as other user AI agents. The online system 140 may use a same or similar process to that described in FIGS. 3A-3B to train a different system AI agent to negotiate with a user AI agent of a different type than the user AI agent 304. For example, the online system 140 may perform steps 310-360 for a user AI agent and a different system AI agent, such that there are a plurality of system AI agents that are trained to negotiate by different user AI agents. Accordingly, one or more system AI agents can be trained in an adversarial manner using user AI agents to respond effectively during negotiations with different users and/or user AI agents. Additionally, by adversarially training the AI agents, the system can identify edge cases, such as in the system AI agent's behavior. For example, by simulating an abundance of user AI agents and negotiation strategies, the robustness of the system AI agents can be tested. This adversarial training may also help simulate outcomes changes are made to any part of the underlying system, including the objectives or constraints. For example, if the objectives for the system AI agents are changed, this system may be used to predict what outcomes should be expected given the user AI agent's strategic response.

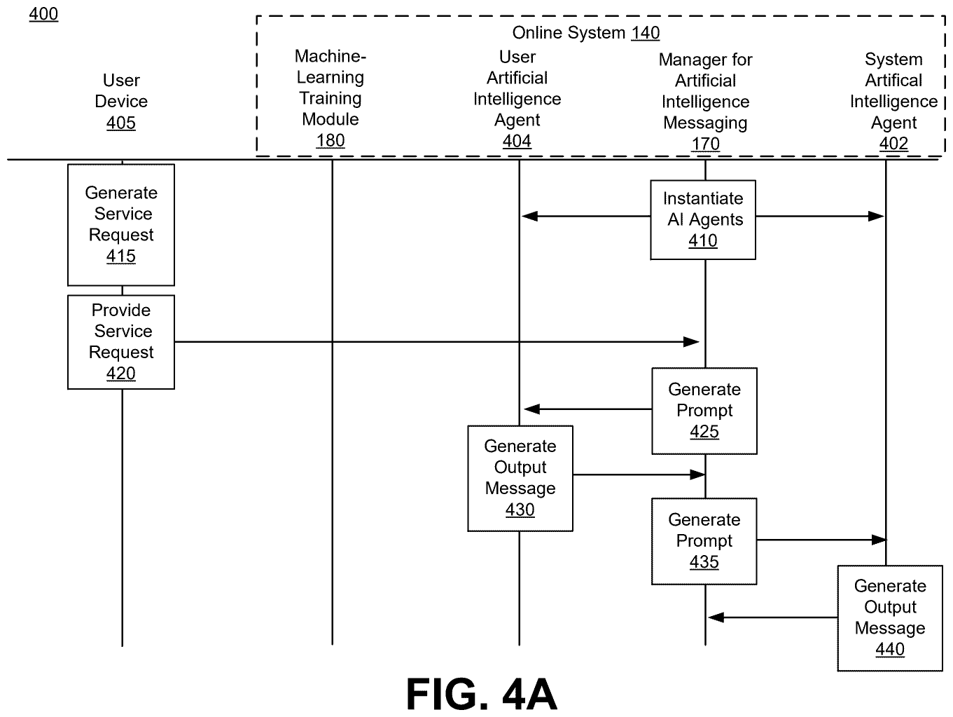

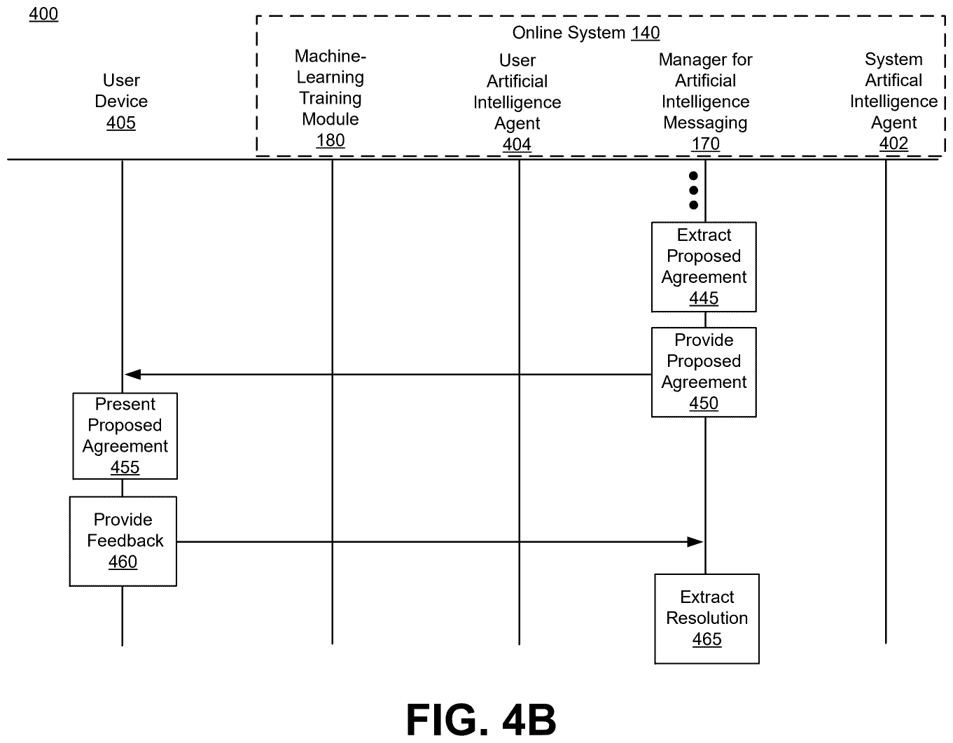

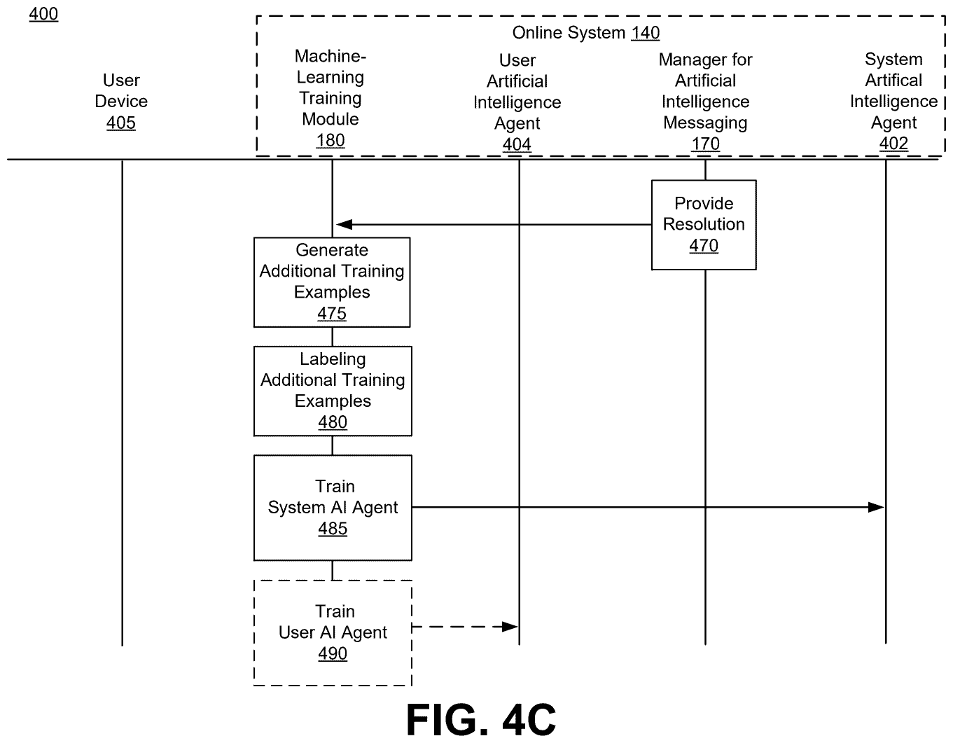

FIGS. 4A-4C show an example sequence diagram 400 describing management of messaging between a system AI agent 402 and a user AI agent 404 that is associated with a user of a user device 405, in accordance with some embodiments. The system AI agent 402 may be an embodiment of the system AI agent 302, and the user AI agent 304 may be an embodiment of the user AI agent 304. Note, that FIGS. 3A-3B describe training of AI agents. In contrast, FIGS. 4A-4C describe use of a trained system AI agent (e.g., the system AI agent 402) with user AI agents (e.g., the user AI agent 404) on behalf of “real” users. Alternative embodiments may include more, fewer, or different interactions from those illustrated in FIGS. 4A-4C, and the steps may be performed in a different order from that illustrated in FIGS. 4A-4C.

The manager for the AI messaging 170 of the online system 140 instantiates 410 a user AI agent 404 and a system AI agent 402. The manager for the AI messaging 170 may create an instance of a system AI agent 402 that comprises a large language model that has been pre-trained using a set of system constraints and a set of system objectives. The manager for the AI messaging 170 may create an instance of a system AI agent 402 comprising a large language model that has been pre-trained using a set of system constraints and a set of system objectives. In some embodiments, some or all of the set of user objectives and/or some or all of the set of user constraints were provided by the user client device 100.

The user device 405 generates 415 a service request. The user device 405 is associated with a user. In embodiments where the user device 405 is the user client device 100, the user may select a list of one or more items (e.g., Brand X Organic Non-Fat Milk, 1 quart) and/or one or more item descriptions (e.g., orange juice) using, e.g., an ordering interface of the user device 405. The user device 405 uses the list to generate the service request. In other embodiments, the user device 405 may be some other device, e.g., the source computing system 120, advertiser device, etc. For example, the user device 405 may be the source computing system 120, and the user may select one or more items to negotiate rate take fees for with the online system 140. The user device may generate a service request based in part on the selection.

The user device 405 provides 420 the service request to the online system 140. In some embodiments, an ordering interface of the user device (e.g., a user client device 100) may include an AI agent option for the user to select, and responsive to the selection, the service request may include instructions for the online system 140 to address the service request using AI agents. Note in alternate embodiments, the online system 140 may perform step 310 responsive to receipt of a service request from the user device 405.

The manager for the AI messaging 170 generates 425 a prompt based in part on the service request. The prompt instructs the user AI agent 404 to generate an output message that is based in part on the service request. The output message may be, e.g., an initial offer that describes details (e.g., items, pricing, delivery time, delivery location, take rate fees, etc.) of a proposal based on the received service request.

In the illustrated embodiment, the prompt is applied (e.g., by the manager for the AI messaging 170) to the user AI agent 404, causing the user AI agent 404 to generate 430 an output message. The user AI agent 404 evaluates the service request to generate a proposal (e.g., one or more items that are part of the online catalog and that satisfy one or more the set of user objectives and the set of user constraints, proposed rate take fees, etc.). The evaluation is performed in view of the set of user constraints and the set of user objectives. The output message is provided to the manager for the AI messaging 170.

The manager for the AI messaging 170 generates 435 a prompt based in part on the output message from the user AI agent 404. For example, the prompt may instruct the system AI agent 402 to evaluate the service request and some or all of the output message to determine whether the proposal would satisfy the service request and one or more system objectives and the set of system constraints, and if not, generate a counteroffer. In some embodiments, the prompt may instruct the system AI agent 402 to consider a discount requested by the user AI agent 404 based on some or all of the set of system objectives and/or some or all of the set of system constraints.

The prompt is applied (e.g., by the manager for the AI messaging 170) to the system AI agent 402, causing the system AI agent 402 to generate 440 an output message. The prompt may cause the system AI agent 402 to evaluate the service request and some or all of the output message to determine whether the proposal from the user AI agent 404 would satisfy the service request and one or more of the set of system objectives and the set of system constraints, and if not, generate a counteroffer.

The back and forth between the user AI agent 404 and the system AI agent 402 via the manager for AI messaging 170 may continue until a proposed agreement that is based in part on the service request is achieved. The manager for AI messaging 170 extracts 445, from the messaging between the user AI agent 404 and the system AI agent 402, a proposed agreement between the user associated with the service request and the online system 140. The manager for AI messaging 170 may extract a proposed agreement once a proposed order based on the service request is approved by both the system AI agent 402 and the user AI agent 404.

In some embodiments, the manager for AI messaging 170 provides 450 the proposed agreement to at least one of the user device 405 and the online system 140. For example, in some embodiments the manager for AI messaging 170 provides the proposed agreement to the user device 405. The user device 405 may present 455 some or all of the proposed agreement to the user for approval or rejection. The user may provide feedback that rejects and/or approves some or all of the proposed agreement. The user device 405 provides 460 the feedback to the online system 140. In embodiments, where the feedback rejects some or all of the proposed agreement, the manager for AI messaging 170 begins a new one or more rounds of messaging between the user AI agent 404 and the system AI agent 402 to negotiate a new proposed agreement based in part on the feedback. For example, steps 425-460 may be repeated until the user approves a proposed agreement.

In embodiments, where the user has approved the proposed agreement, the online system 140 proceeds in accordance with the proposed agreement. Note in alternate embodiments (e.g., if authorized by the user), once a proposed agreement is approved by both the user AI agent 404 and the system AI agent 402, the online system 140 may proceed in accordance with the proposed agreement without sending it to the user device 405 for express approval by the user.

Once a proposed agreement is approved, the manager for AI messaging 170 extracts 465 a resolution. The extracted resolution describes at least in part on the proposed agreement, and is a resolution to the service request. The resolution may cover, e.g., items for purchase, pricing for items, delivery time, delivery location, source for the items, incentives (that would be applied to the order and/or a future order), take rate fees, ad impression fees, etc.

The manager for AI messaging 170 provides 470 the resolution to the machine-learning training module 180. Steps 410-470 repeat a plurality of times for different service requests. As such, over time, the machine-learning training module 180 collects, among other information, information describing different service requests from the user device 405 and information describing resolutions to those service requests.

In the illustrated embodiment, the manager for AI messaging 170 first generates 425 the prompt for the user AI agent 404. In other embodiments, the manager for AI messaging 170 first generates 425 the prompt for the system AI agent 402. Regardless of which AI agent is prompted first, the manager for AI messaging 170 may manage the resulting one or more rounds of messaging between the user AI agent 404 and the system AI agent 402 to obtain a resolution to the service request.

The machine-learning training module 180 generates 475 additional training examples. The additional training examples are based in part on the service requests from the user AI agent 404 and the resolutions to the service requests. For example, an additional training example, may include at least training messaging data, but also may include, e.g., training picker data, training item data, training order data, training user data, or some combination thereof.

The machine-learning training module 180 may label 480 some or all of the additional training examples. The machine-learning training module 180 may label an additional training example based on a comparison of a resolution of the additional training example to one or more performance metrics of the online system 140. The performance metric may be based in part on a type of the user AI agent 404.

The machine-learning training module 180 trains 485 the system AI agent 402 using some or all of the labeled additional training examples. The machine-learning training module 180 may generate a labeled training example (e.g., an example of what is or is not desired) based on the comparison of the resolution to the metric associated with the online system 140. The machine-learning training module 180 may retrain or otherwise tune the AI agents with this training example. In this manner, the system AI agent 402 may be further trained using real-world describing negotiations between the system AI agent 402 and the user AI agent 404.

In some embodiments, the machine-learning training module 180 also trains 490 the user AI agent 404 using the additional training examples. The machine-learning training module 180 may label each training example based on a comparison of a resolution of the training example to one or more performance metrics of the user AI agent 404. The performance metric may be based in part on, e.g., how effective the user AI agent 404 was in meeting the set of user objectives and the set of user constraints. In this manner, the user AI agent 404 may be further trained using real-world interactions.

The negotiation between the user AI agent 404 and the system AI agent 402 can quickly identify items that not only meet one or more user constraints and/or one or more user objectives but also meet one or more system objectives and/or one or more system constraints. In this manner, the online system 140 is able to fulfill orders that not only satisfy the user, but also, e.g., satisfy sources (e.g., helping turn over inventory), generate advertisement revenue (e.g., presenting ad for substitute item), etc. Moreover, the online system 140 is able to further train the system AI agent 402 (and in some embodiments also further train the user AI agent 404) based on these negotiations with user AI agents associated with “real” users.

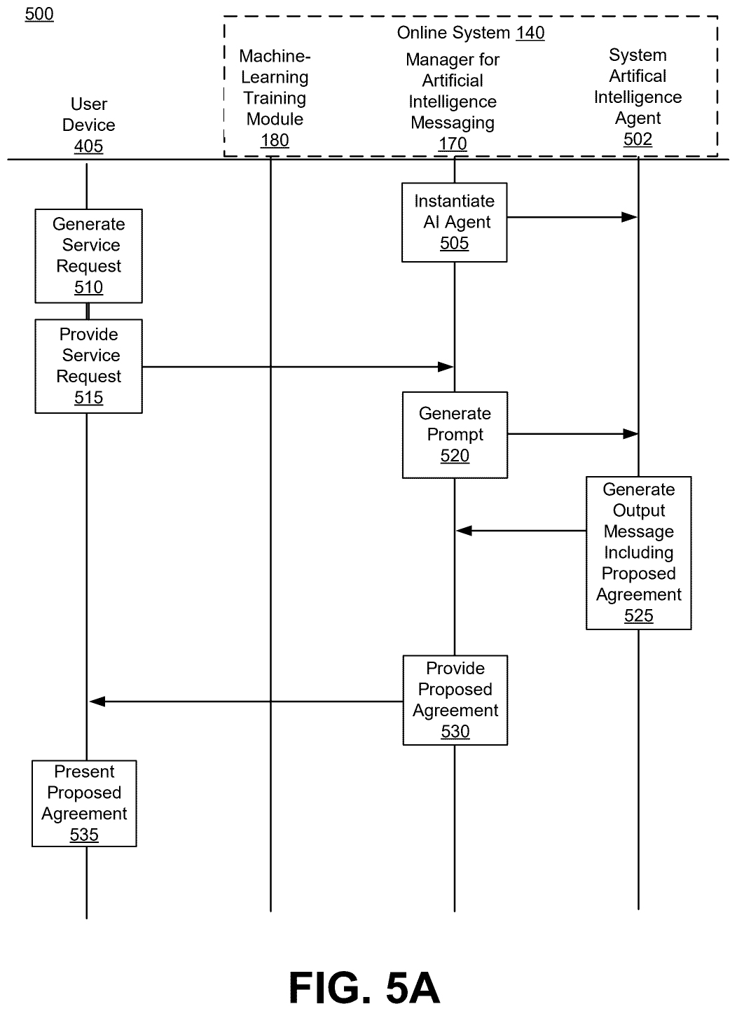

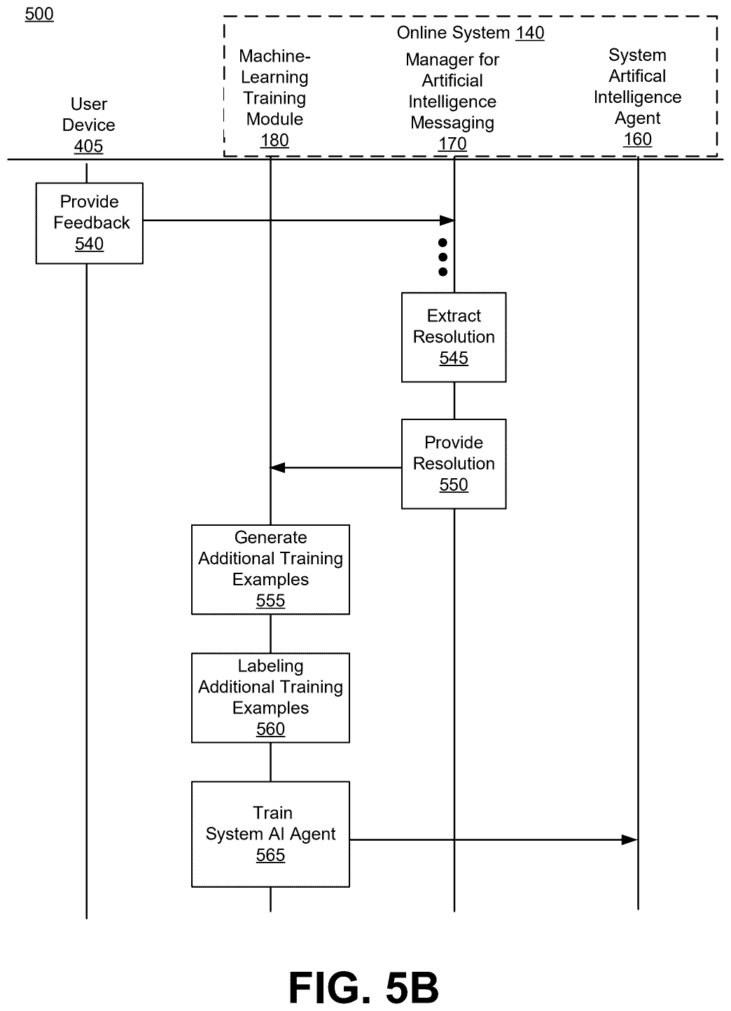

FIGS. 5A-5B is an example sequence diagram 400 describing management of messaging between a system AI agent 402 and the user device 405 of a user, in accordance with some embodiments. The system AI agent 402 may be an embodiment of the system AI agent 302. Note, that FIGS. 3A-3B describe training of AI agents. In contrast, FIGS. 5A-5B describe use of a trained system AI agent (e.g., the system AI agent 402) with “real” users. Alternative embodiments may include more, fewer, or different interactions from those illustrated in FIGS. 5A-5B, and the steps may be performed in a different order from that illustrated in FIGS. 5A-5B.

The manager for the AI messaging 170 of the online system 140 instantiates 505 a system AI agent 502. The manager for the AI messaging 170 may create an instance of a system AI agent 502 that comprises a large language model that has been pre-trained using a set of system constraints and a set of system objectives.

The user device 405 generates 510 a service request. The user device may generate the service request in a substantially similar manner to that described above with regard to step 415. The user device 405 provides 515 the service request to the online system 140.

The manager for the AI messaging 170 generates 520 a prompt based in part on the service request. The manager for the AI messaging 170 may retrieve from a data store (e.g., the data store 240) information about previous interactions of the user of the user device 405 with the online system 140. The manager for the AI messaging 170 may prompt the system AI agent 502 to determine a proposed agreement based in part on the service request and the information about previous interactions of the user with the online system 140. Responsive to the prompt, the system AI agent 502 generates 525 an output message that includes a proposed agreement to the service request.

The online system 140 may output the proposed agreement to one or more of the user device 405 or the online system 140. For example, in some embodiments the manager for AI messaging 170 provides 530 the proposed agreement to the user device 405. The user device 405 may present 535 some or all of the proposed agreement to the user for approval or rejection. The user may provide feedback that rejects and/or approves some or all of the proposed agreement. The user device 405 provides 540 the feedback to the online system 140. In embodiments, where the feedback rejects some or all of the proposed agreement, the manager for AI messaging 170 begins a new one or more rounds of messaging between the system AI agent 402 and the user device 405 to negotiate a new proposed agreement based in part on the feedback. For example, steps 520-540 may be repeated until the user approves a proposed agreement.

Once a proposed agreement is approved, the manager for AI messaging 170 extracts 545 a resolution. The extracted resolution describes at least in part on the proposed agreement, and is a resolution to the service request. The resolution may cover, e.g., items for purchase, pricing for items, delivery time, delivery location, source for the items, incentives (that would be applied to the order and/or a future order), take rate fees, ad impression fees, etc.

The manager for AI messaging 170 provides 550 the resolution to the machine-learning training module 180. Steps 505-550 may repeat a plurality of times for different service requests. As such, over time, the machine-learning training module 180 collects, among other information, information describing different service requests from the user device 405 and information describing resolutions to those service requests.

The machine-learning training module 180 generates 555 additional training examples. The additional training examples are based in part on the service requests from the user device 405 and the resolutions to the service requests. For example, an additional training example, may include at least messaging data, but also may include, e.g., picker data, item data, order data, user data, or some combination thereof.

The machine-learning training module 180 may label 560 some or all of the additional training examples. The machine-learning training module 180 may label an additional training example based on a comparison of a resolution of the additional training example to one or more performance metrics of the online system 140.

The machine-learning training module 180 trains 565 the system AI agent 502 using some or all of the labeled training examples. The machine-learning training module 180 may update a set of parameters of or otherwise tune the large language model associated with the system AI agent 502 using the labeled training examples. In this manner, the system AI agent 502 may be further trained using real-world data describing negotiations between the system AI agent 502 with the user device 405.

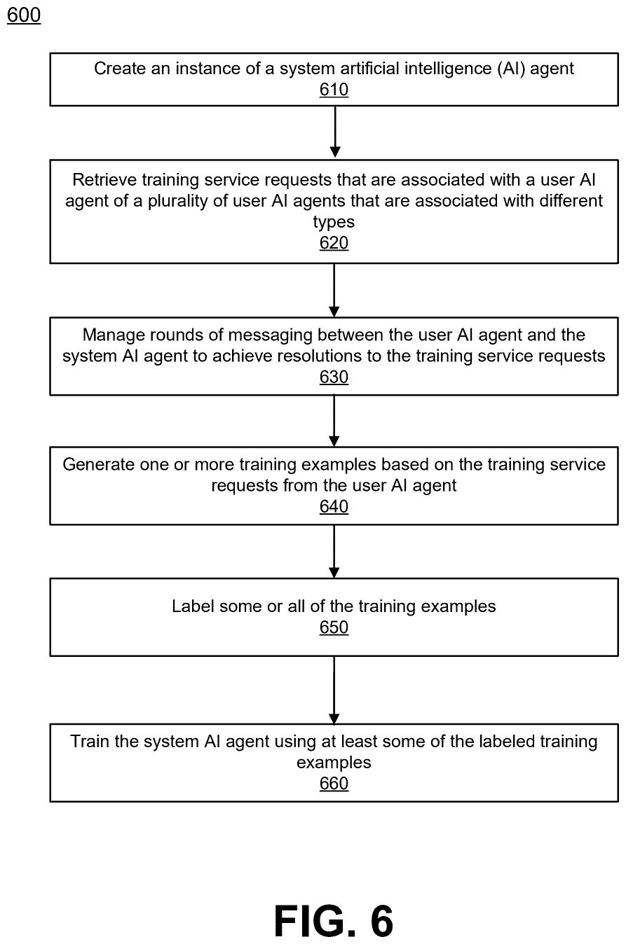

FIG. 6 is a flowchart for a method 600 of adversarial training of AI agents, in accordance with some embodiments. Alternative embodiments may include more, fewer, or different steps from those illustrated in FIG. 6, and the steps may be performed in a different order from that illustrated in FIG. 6. These steps may be performed by an online system (e.g., online system 140). Additionally, each of these steps may be performed automatically by the online system without human intervention.

The online system creates 610 an instance of a system AI agent. The system AI agent is comprised of a large language model that has been pre-trained using a set of system constraints and a set of system objectives.

The online system retrieves 620 training service requests that are associated with a user AI agent of a plurality of user AI agents that are associated with different types. The online system may, e.g., retrieve the training service requests from a data store (e.g., the data store 240). Each user AI agent may be a separate large language model that was pre-trained using a set of training user constraints and a set of training user objectives. In some embodiments, the set of training user constraints and the set of training user objectives differ from those used to pretrain at least one other user AI agent. The set of training user constraints and the set of training user objectives used to pre-train a user AI agent may in part determine a type (e.g., a negotiation style) of the user AI agent.

The online system manages 630 rounds of messaging between the user AI agent and the system AI agent to achieve resolutions to the training service requests. For example, a manager for AI messaging (e.g., the manager for AI messaging 170) of the online system may prompt the user AI agent based in part on the training service requests. The manager for AI messaging may receive, from the user AI agent, output messages including proposals that address the training service requests. The manager for AI messaging may prompt the system AI agent based on the output messages from the user AI agent. The manager for AI messaging may receive, from the system AI agent, output messages for the user AI agent. The output messages from the system AI agent may, e.g., approve or reject the proposals from the user AI agent. In embodiments, where the system AI agent has rejected at least a portion of a proposal, the system AI agent may generate a counteroffer as part of the output message.

The back and forth between a user AI agent and the system AI agent (via the manager for AI messaging 170) may continue until a resolution that is based in part on the training service request is achieved. The manager for AI messaging extracts, from the messaging between the user AI agent and the system AI agent, resolutions describing agreements between the user AI agent and the system AI agent.

The online system generates 640 one or more training examples based on at least some of the training service requests from the user AI agent. For example, a training example, may include at least messaging data, but also may include, e.g., picker data, item data, order data, user data, or some combination thereof. In some embodiments, each training example includes, for a given service request and corresponding resolution, at least one round of messaging of the rounds of messaging.

The online system labels 650 some or all of the training examples. The online system may label a training example based on a comparison of a resolution of the training example to a metric (e.g., number of messaging rounds till resolution was achieved, profit made on transaction, to what extent system objectives were met and/or exceeded, etc.) with the online system.

In the above manner, the system AI agent can be trained in an adversarial manner to negotiate with user AI agents and/or user devices having a same (or substantially similar) type to that of the user AI agent. In some embodiments, the online system may use a same or similar process to train the system AI agent (and/or other system AI agents) using other user AI agents of different types, such the system AI agent (and/or other system AI agents) can effectively negotiate with user AI agents and/or user devices having same (or substantially similar) types to that of the other user AI agents. Accordingly, one or more system AI agents can be trained in an adversarial manner using user AI agents to respond effectively during negotiations with different users and/or user AI agents.

Moreover, the trained one or more system AI agents may be used to determine resolutions to service requests from user devices and/or user AI agents representing “real” users. And data from those interactions may further be used to refine the one or more system AI agents.

The foregoing description of the embodiments has been presented for the purpose of illustration; many modifications and variations are possible while remaining within the principles and teachings of the above description.

Any of the steps, operations, or processes described herein may be performed or implemented with one or more hardware or software modules, alone or in combination with other devices. In some embodiments, a software module is implemented with a computer program product comprising one or more computer-readable media storing computer program code or instructions, which can be executed by a computer processor for performing any or all of the steps, operations, or processes described. In some embodiments, a computer-readable medium comprises one or more computer-readable media that, individually or together, comprise instructions that, when executed by one or more processors, cause the one or more processors to perform, individually or together, the steps of the instructions stored on the one or more computer-readable media. Similarly, a processor comprises one or more processors or processing units that, individually or together, perform the steps of instructions stored on a computer-readable medium.

Embodiments may also relate to a product that is produced by a computing process described herein. Such a product may store information resulting from a computing process, where the information is stored on a non-transitory, tangible computer-readable medium and may include a computer program product or other data combination described herein.

The description herein may describe processes and systems that use machine-learning models in the performance of their described functionalities. A “machine-learning model,” as used herein, comprises one or more machine-learning models that perform the described functionality. Machine-learning models may be stored on one or more computer-readable media with a set of weights. These weights are parameters used by the machine-learning model to transform input data received by the model into output data. The weights may be generated through a training process, whereby the machine-learning model is trained based on a set of training examples and labels associated with the training examples. The training process may include: applying the machine-learning model to a training example, comparing an output of the machine-learning model to the label associated with the training example, and updating weights associated with the machine-learning model through a back-propagation process. The weights may be stored on one or more computer-readable media, and are used by a system when applying the machine-learning model to new data.

The language used in the specification has been principally selected for readability and instructional purposes, and it may not have been selected to narrow the inventive subject matter. It is therefore intended that the scope of the patent rights be limited not by this detailed description, but rather by any claims that issue on an application based hereon.

As used herein, the terms “comprises,” “comprising,” “includes,” “including,” “has,” “having,” or any other variation thereof, are intended to cover a non-exclusive inclusion. For example, a process, method, article, or apparatus that comprises a list of elements is not necessarily limited to only those elements but may include other elements not expressly listed or inherent to such process, method, article, or apparatus. Further, unless expressly stated to the contrary, “or” refers to an inclusive “or” and not to an exclusive “or.” For example, a condition “A or B” is satisfied by any one of the following: A is true (or present) and B is false (or not present); A is false (or not present) and B is true (or present); and both A and B are true (or present). Similarly, a condition “A, B, or C” is satisfied by any combination of A, B, and C being true (or present). As a non-limiting example, the condition “A, B, or C” is satisfied when A and B are true (or present) and C is false (or not present). Similarly, as another non-limiting example, the condition “A, B, or C” is satisfied when A is true (or present) and B and C are false (or not present).

What is claimed is:

1. A method, performed at a computer system comprising a processor and a computer-readable medium of an online system, comprising:
creating an instance of a system artificial intelligence (AI) agent comprising a large language model that has been pre-trained using a set of system constraints and a set of system objectives;
retrieving training service requests that are associated with a user AI agent of a plurality of user AI agents that are associated with different types, where each user AI agent is a separate large language model that was pre-trained using a set of training user constraints and a set of training user objectives that differ from at least one other user AI agent and in part determine the type of the user AI agent;
managing rounds of messaging between the user AI agent and the system AI agent to achieve resolutions to the training service requests;
generating training examples based on the training service requests from the user AI agent, each training example including, for a given service request and corresponding resolution, at least one round of messaging of the rounds of messaging;
labeling each training example based on a comparison of a resolution of the training example to a metric associated with the online system; and
training the system AI agent using the labeled training examples, wherein the trained system AI agent is used to determine a resolution for a service request that is associated with a user.

2. The method of claim 1, further comprising:
retrieving training service requests that are associated with a second user AI agent of the plurality of user AI agents;
managing additional rounds of messaging between the second user AI agent and the system AI agent to achieve resolutions to the training service requests from the second user AI agent;
generating additional training examples based on the training service requests from the second user AI agent, each training example including, for a given service request and corresponding resolution, at least one round of messaging of the additional rounds of messaging;
labeling each additional training example based on a comparison of a resolution of the additional training example to a metric associated with the online system; and
training the system AI agent using the labeled additional training examples, wherein the trained system AI agent is used to determine a resolution for a service request that is associated with a second user.

3. The method of claim 1, further comprising:
creating an instance of a second system AI agent comprising a large language model that has been trained using a second set of system constraints and a second set of system objectives;
retrieving training service requests that are associated with a second user AI agent of the plurality of user AI agents;
managing rounds of messaging between the second user AI agent and the second system AI agent to achieve resolutions to the training service requests from the second user AI agent;
generating additional training examples based on the training service requests from the second user AI agent;
labeling each additional training example based on a comparison of a resolution of the additional training example to a metric associated with the online system; and
training the second system AI agent using the labeled additional training examples, wherein the trained second system AI agent is used to determine a resolution for a service request that is associated with a second user.

4. The method of claim 1, further comprising:
receiving a service request from a user device associated with a user;
retrieving, from a data store maintained by the online system, information about previous interactions of the user with the online system;
prompting the system AI agent to determine a proposed agreement based in part on the service request and the information about previous interactions of the user with the online system; and
outputting the proposed agreement to one or more of the user device or the online system.

5. The method of claim 4, further comprising:
determining a resolution to the service request using the proposed agreement;
generating an additional training example that includes the service request, the resolution, and the information about previous interactions of the user with the online system;
labeling the additional training example based on a comparison of the resolution of the additional training example to a metric associated with the online system; and
training the system AI agent using the labeled additional training example.

6. The method of claim 1, further comprising:
receiving a service request from a user device associated with a user;
retrieving, from a data store maintained by the online system, information about previous interactions of the user with the online system;
prompting the user AI agent to generate a message to the online system based on the received service request;
managing rounds of messaging between the user AI agent and the system AI agent to achieve a resolution to the service request from the user AI agent; and
outputting the resolution to one or more of the user device or the online system.

7. The method of claim 6, further comprising:
generating an additional training example that includes the service request, the resolution, and the information about previous interactions of the user with the online system;
labeling the additional training example based on a comparison of the resolution of the additional training example to a metric associated with the online system; and
training the system AI agent using the labeled additional training example.

8. The method of claim 1, wherein managing the rounds of messaging between the user AI agent and the system AI agent to achieve resolutions to the service requests, comprises:
for a round of messaging,
receiving, from the user AI agent, output messages,
prompting the system AI agent based on the output messages from the user AI agent,
receiving, from the system AI agent, output messages for the user AI agent, and
prompting the user AI agent based on the output messages from the system AI agent.

9. The method of claim 1, further comprising:
pre-training the system AI agent with the set of system constraints and the set of system objectives.

10. The method of claim 1, wherein training the system AI agent using the labeled training examples comprises:
for each labeled training example, updating system AI agent based on the labeled training example.

11. The method of claim 1, further comprising:
training the user AI agent using the training examples.

12. A computer program product comprising a non-transitory computer readable storage medium having instructions encoded thereon that, when executed by a processor of a computer system, cause the computer system to perform steps comprising:
creating an instance of a system artificial intelligence (AI) agent comprising a large language model that has been pre-trained using a set of system constraints and a set of system objectives;
retrieving training service requests that are associated with a user AI agent of a plurality of user AI agents that are associated with different types, where each user AI agent is a separate large language model that was pre-trained using a set of training user constraints and a set of training user objectives that differ from at least one other user AI agent and in part determine the type of the user AI agent;
managing rounds of messaging between the user AI agent and the system AI agent to achieve resolutions to the training service requests;
generating training examples based on the training service requests from the user AI agent, each training example including, for a given service request and corresponding resolution, at least one round of messaging of the rounds of messaging;
labeling each training example based on a comparison of a resolution of the training example to a metric associated with an online system; and
training the system AI agent using the labeled training examples, wherein the trained system AI agent is used to determine a resolution for a service request that is associated with a user.

13. The computer program product of claim 12, further comprising encoded instructions that when executed cause the computer system to perform steps comprising:
retrieving training service requests that are associated with a second user AI agent of the plurality of user AI agents;
managing additional rounds of messaging between the second user AI agent and the system AI agent to achieve resolutions to the training service requests from the second user AI agent;
generating additional training examples based on the training service requests from the second user AI agent;
labeling each additional training example based on a comparison of a resolution of the additional training example to a metric associated with the online system; and
training the system AI agent using the labeled additional training examples, wherein the trained system AI agent is used to determine a resolution for a service request that is associated with a second user.

14. The computer program product of claim 12, further comprising encoded instructions that when executed cause the computer system to perform steps comprising:
creating an instance of a second system AI agent comprising a large language model that has been trained using a second set of system constraints and a second set of system objectives;
retrieving training service requests that are associated with a second user AI agent of the plurality of user AI agents;
managing rounds of messaging between the second user AI agent and the second system AI agent to achieve resolutions to the training service requests from the second user AI agent;
generating additional training examples based on the training service requests from the second user AI agent;
labeling each additional training example based on a comparison of a resolution of the additional training example to a metric associated with the online system; and
training the second system AI agent using the labeled additional training examples, wherein the trained second system AI agent is used to determine a resolution for a service request that is associated with a second user.

15. The computer program product of claim 12, further comprising encoded instructions that when executed cause the computer system to perform steps comprising:
receiving a service request from a user device associated with a user;
retrieving, from a data store maintained by the online system, information about previous interactions of the user with the online system;
prompting the system AI agent to determine a proposed agreement based in part on the service request and the information about previous interactions of the user with the online system; and
outputting the proposed agreement to one or more of the user device or the online system.

16. The computer program product of claim 15, further comprising encoded instructions that when executed cause the computer system to perform steps comprising:
determining a resolution to the service request using the proposed agreement;
generating an additional training example that includes the service request, the resolution, and the information about previous interactions of the user with the online system;
labeling the additional training example based on a comparison of the resolution of the additional training example to a metric associated with the online system; and
training the system AI agent using the labeled additional training example.

17. The computer program product of claim 12, further comprising encoded instructions that when executed cause the computer system to perform steps comprising:
receiving a service request from a user device associated with a user;
retrieving, from a data store maintained by the online system, information about previous interactions of the user with the online system;
prompting the user AI agent to generate a message to the online system based on the received service request;
managing rounds of messaging between the user AI agent and the system AI agent to achieve a resolution to the service request from the user AI agent; and
outputting the resolution to one or more of the user device or the online system.

18. The computer program product of claim 17, further comprising encoded instructions that when executed cause the computer system to perform steps comprising:
generating an additional training example that includes the service request, the resolution, and the information about previous interactions of the user with the online system;
labeling the additional training example based on a comparison of the resolution of the additional training example to a metric associated with the online system; and
training the system AI agent using the labeled additional training example.

19. The computer program product of claim 12, wherein the encoded instructions for training the system AI agent using the labeled training examples cause the computer system to perform steps comprising:
for each labeled training example, updating system AI agent based on the labeled training example.

20. A computer system comprising:
a processor; and
a non-transitory computer readable storage medium having instructions encoded thereon that, when executed by the processor, cause the computer system to perform steps comprising:
creating an instance of a system artificial intelligence (AI) agent comprising a large language model that has been pre-trained using a set of system constraints and a set of system objectives,
retrieving training service requests that are associated with a user AI agent of a plurality of user AI agents that are associated with different types, where each user AI agent is a separate large language model that was pre-trained using a set of training user constraints and a set of training user objectives that differ from at least one other user AI agent and in part determine the type of the user AI agent,
managing rounds of messaging between the user AI agent and the system AI agent to achieve resolutions to the training service requests,
generating training examples based on the training service requests from the user AI agent, each training example including, for a given service request and corresponding resolution, at least one round of messaging of the rounds of messaging,
labeling each training example based on a comparison of a resolution of the training example to a metric associated with an online system, and
training the system AI agent using the labeled training examples, wherein the trained system AI agent is used to determine a resolution for a service request that is associated with a user.
